(19) United States
(12) Patent Application Publication
(10) Pub. No.: US 2022/0030534 A1
(43) Pub. Date: Jan. 27, 2022

(54) User Equipment, Radio Network Node and Methods for Managing Synchronization Signals

(71) Applicant: Telefonaktiebolaget LM Ericsson (PUBL), Stockholm (SE)

(72) Inventor: Pablo SOLDATI, SOLNA (SE)

(21) Appl. No.: 17/428,010

(22) PCT Filed: Feb. 14, 2020
(86) PCT No.: PCT/SE2020/050167

§ 371 Date: Aug. 3, 2021

Related U.S. Application Data
(60) Provisional application No. 62/805,343, filed on Feb. 14, 2019.

(51) Int. Cl. H04W 56/00

(52) U.S. Cl. CPC H04W 56/0015

(57) ABSTRACT

According to an embodiment a method is disclosed, performed by a radio network node (12), for managing synchronization signals in a wireless communication network. The radio network node determines a first cell identity value for a non-cell defining, non-CD, synchronization signal, wherein the first cell identity value is determined as a function of a second cell identity value of a cell defining, CD, synchronization signal transmitted by the radio network node (12). The radio network node configures the non-CD synchronization signal based on said determined first cell identity value; and transmits the non-CD synchronization signal as configured.

### TECHNICAL FIELD

Embodiments herein relate to a user equipment (UE), a radio network node and methods performed therein regarding wireless communication. Furthermore, a computer program product and a computer readable storage medium are also provided herein. In particular, embodiments herein relate to handling communication, such as handle or manage synchronization signals and/or system information (SI), in an efficient manner in a wireless communications network.

### BACKGROUND

In a typical wireless communications network, user equipment (UE), also known as wireless communication devices, mobile stations, stations (STA) and/or wireless devices, communicate via a Radio Access Network (RAN) with one or more core networks (CN). The RAN covers a geographical area which is divided into service areas or cell areas, with each service area or cell area being served by radio network node such as an access node e.g. a Wi-Fi access point or a radio base station (RBS), which in some networks may also be called, for example, a NodeB, a gNodeB, or an eNodeB. The service area or cell area is a geographical area where radio coverage is provided by the radio network node. The radio network node operates on radio frequencies to communicate over an air interface with the UEs within range of the radio network node. The radio network node communicates over a downlink (DL) to the UE and the UE communicates over an uplink (UL) to the radio network node.

A Universal Mobile Telecommunications System (UMTS) is a third generation telecommunication network, which evolved from the second generation (2G) Global System for Mobile Communications (GSM). The UMTS terrestrial radio access network (UTRAN) is essentially a RAN using wideband code division multiple access (WCDMA) and/or High-Speed Packet Access (HSPA) for communication with user equipment. In a forum known as the Third Generation Partnership Project (3GPP), telecommunications suppliers propose and agree upon standards for present and future generation networks and UTRAN specifically, and investigate enhanced data rate and radio capacity. In some RANs, e.g. as in UMTS, several radio network nodes may be connected, e.g., by landlines or microwave, to a controller node, such as a radio network controller (RNC) or a base station controller (BSC), which supervises and coordinates various activities of the plural radio network nodes connected thereto. The RNCs are typically connected to one or more core networks.

Specifications for the Evolved Packet System (EPS) have been completed within the 3GPP and this work continues in the coming 3GPP releases, such as 4G and 5G networks such as New Radio (NR). The EPS comprises the Evolved Universal Terrestrial Radio Access Network (E-UTRAN), also known as the Long-Term Evolution (LTE) radio access network, and the Evolved Packet Core (EPC), also known as System Architecture Evolution (SAE) core network. E-UTRAN/LTE is a 3GPP radio access technology wherein the radio network nodes are directly connected to the EPC core network. As such, the Radio Access Network (RAN) of an EPS has an essentially “flat” architecture comprising radio network nodes connected directly to one or more core networks.

With the emerging 5G technologies such as new radio (NR), the use of very many transmit- and receive-antenna elements is of great interest as it makes it possible to utilize beamforming, such as transmit-side and receive-side beamforming. Transmit-side beamforming means that the transmitter can amplify the transmitted signals in a selected direction or directions, while suppressing the transmitted signals in other directions. Similarly, on the receive-side, a receiver can amplify signals from a selected direction or directions, while suppressing unwanted signals from other directions.

The 3GPP New Radio (NR) system defines synchronization signals in terms of spatially distributed Synchronization Signals e.g. synchronization signal block (SSB) and physical broadcast channel (PBCH) blocks, e.g. 3GPP TS 38.211 v.15.0.0, which may be regarded as spatial beams transmitted in a short time burst within a same frequency location of a frequency carrier. Each SSB consists of
A Primary Synchronization Signal (PSS) occupying 1 OFDM symbol and 127 subcarriers
A Secondary Synchronization Signal (SSS) occupying 1 OFDM symbol and 127 subcarriers
A Physical Broadcast Channel (PBCH) signal occupying 3 OFDM symbol and 240 subcarriers

FIG. 1 illustrates a Synchronization Signal and PBCH Block (SSB) for 3GPP NR system.

The detailed time-frequency structure and PSS/SSS/PBCH mapping for SS/PBCH blocks is defined in clause 7.4.3 of TS 38.211 v.15.0.0. The PSS provides a radio frame boundary, i.e., the position of 1st symbol in a radio frame, while the SSS provides a subframe boundary, i.e. the position of 1st Symbol in a Subframe.

Depending on the antenna array available at the radio network node, a radio network node may configure an SSB burst transmission consisting of up to L=64 SS/PBCH blocks within a half frame duration. For a half frame with SS and PBCH blocks, the time location for candidate SS and PBCH blocks is defined by the first symbol indexes which are determined according to the subcarrier spacing of SS and PBCH blocks as defined in clause 4.1 of TS 38.213 v.15.0.0, where index 0 corresponds to the first symbol of the first slot in a half-frame.

The SSB signal burst transmission is repeated periodically over time with periodicity configurable by the radio network node within the values {5 ms, 10 ms, 20 ms, 40 ms, 80 ms, 160 ms}. Each SS and PBCH block within a SSB signal burst, i.e, within the 5 ms half frame period, is associated with a unique SSB block index 1=0, . . . , L−1. The SSB block index 1 is reset to 0 in the next SSB burst transmission, i.e, in the next half frame after where a new SSB burst is transmitted. The SS and PBCH blocks index is signaled to the UE 10 via two different parameters within SSBlock: one part, referred to as i_{SSB} parameter, is carried by PBCH demodulation reference signal (DMRS); and the second parameter is carried by PBCH Payload.

Each SS/PBCH block may be interpreted as a radio beam or a radio cell. Therefore, the notion of radio beam, or SS and PBCH block throughout this disclosure will interchangeably be used. Furthermore, the terms SSB, SSB signal, or SSB burst are interchangeably used to indicate the entirety of L SS and PBCH blocks that a radio network node may transmit within a half radio frame in a given frequency location.

Physical Cell Identity Definition for SS/PBCH Block.

Each SS and PBCH block encodes a Physical Cell Identity (PCI) N_{ID}^{Cell} defined as a function of two parameters N_{ID}⁽¹⁾ and N_{ID}⁽²⁾, wherein
N_{ID}⁽¹⁾ is an integer in the range {0, 1, . . . , 335} encoded in the SSS transmission;
N_{ID}⁽²⁾ is an integer in the range {0, 1, 2} encoded in the PSS transmission.

The 3GPP NR specification provides 1008 unique physical-layer cell identities by defining the PCI as N_{ID}^{Cell}=3N_{ID}⁽¹⁾+N_{ID}⁽²⁾. Upon detecting and decoding the PSS and SSS signals within a SS or PBCH block, a UE may retrieve the PCI of the cell to which the SSB transmission belongs to.

Multiple SSB within a Frequency Carrier.

Within the frequency span of a frequency carrier, a radio network node may transmit multiple SSB at different frequency locations. Each SS and PBCH block indexed by 1=0, . . . , L−1 within a SSB signal burst transmission in a certain frequency location is configured with the same PCI. However, the PCI of SSB signals transmitted in different frequency locations may not be unique. This may create an issue in identifying from which radio access node (or cell) an SSB signal is transmitted from, as further described below.

As stated above, within the frequency span of a carrier, a radio network node may transmit multiple SSB bursts at different frequency locations. The 3GPP NR specifications distinguish between Cell-Defining SSB (CD-SSB) and non-Cell-Defining SSB (non-CD-SSB). A CD-SSB is an SSB associated with a Remaining Minimum System Information (RMSI) and corresponds to an individual cell with a unique cell global identity (CGI), e.g. clause 8.2, TS 38.300 v.15.0.0. For instance, a Primary Cell (Pcell) is always associated to a CD-SSB located in the synchronization raster. CD-SSB may comprise synchronization signals associated to a cell ID of a radio network node and non-CD-SSB may comprise synchronization signals associated to a cell ID but not of the radio network node.

Therefore, within the frequency spam of a carrier, a radio network node may transmit one CD-SSB signal and multiple non-CD-SSB signals at different frequency locations, where the non-CD-SSB signal can be characterised by a same PCI value of the corresponding CD-SSB signal or by a different PCI value. In the 3GPP NR system, the SSB configuration may be exchanged between radio network nodes whenever the Xn interface exists between two radio network nodes. To this end, the MeasurementTimingConfiguration message, which provides assistance information for measurement timing between eNB and gNB, cf. 3GPP TS 38.331 v.15.0.0, may be used to inform a radio network node about the SSB configuration in the neighboring NR cells. This enables an LTE radio network node to configure NR-capable UEs to monitor the signal strength of neighboring NR cells.

However, there may be deployments wherein an Xn interface does not exist between neighbouring radio network nodes, in which case the SSB configuration of neighbouring radio network nodes is unknown.

Performing a Cell Search.

The pattern of SS and PBCH blocks within an SSB signal is indirectly specified by a cell search procedure in TS 38.213 v.15.0.0, which describes locations in which the UE may detect an SS and PBCH block. There are 5 block patterns, Case A-Case E, which have different subcarrier spacing and are applicable for different carrier frequencies. The location, starting OFDM symbol index, of the L SS/PBCH blocks implicitly specifies the SSB index number l=0, . . . , L−1.

More specifically, the candidate SS and PBCH blocks in a half frame are indexed in an ascending order in time from 0 to L−1. A UE determines the 2 least significant bit (LSB) bits, for =4, or the 3 LSB bits, for L>4, of a SS and PBCH block index per half frame from a one-to-one mapping with an index of the DMRS sequence transmitted in the PBCH. For L=64, the UE determines the 3 most significant bit (MSB) bits of the SS/PBCH block index per half frame from PBCH payload bits α̅_{Ā+5}, α̅_{Ā+6}, α̅_{Ā+7}, as described in [clause 4, TS 38.212 v.15.0.0.]

Automatic Neighbor Relation (ANR) and PCI Handling.

ANR is feature that automatically creates neighbor relations between radio network nodes, e.g., eNBs, gNBs, either via the UE reports of neighbouring cell global identity (CGI) or via neighbor cell information exchanged over inter-node X2 or Xn interface. The objective of ANR is to obtain an identity, e.g. Cell Global Identity (CGI), associated to a neighbour cell and associated radio network node. Based on the CGI, the radio network node may obtain the transport network layer (TNL) address at a TNL address discovery procedure, and establish a signalling path to the neighbouring radio network node, setup Xn connection, etc. The latter steps are similar to LTE, and therefore it will be focused on obtaining an identity of a neighbouring radio network node.

More specifically, there are two known approaches a radio network node may obtain a CGI associated to a potential neighbour radio network node:

X2/Xn based ANR establishment: ANR required data, including PCI, CGI, tacking area code (TAC) and RAN-based Notification Area Code (RANAC) of all cells supported by eNB and gNB can be exchanged over X2 or Xn setup and configuration update message, in the served cell information information element (IE). Neighbouring radio network nodes and associated cells information are also available in this signalling that can be used to create a relation to the neighbour of neighbour.

NR-SSB based Measurement Procedure: In this approach the ANR is based on a similar concept as LTE ANR with a procedure based on downlink measurements of cell defining SSBs. LTE ANR considers broadcast of both a locally and a globally unique radio network node identifier. The locally unique identifier in NR, the PCI, is associated to NR-PSS/SSS that the UE can detect and identify blindly, i.e. without any prior information about the signals. In addition, the UE may also retrieve the SS block index from the target cell to support mobility control information that is associated to the report cell and SS block. In case the source radio network node is unable to identify the target SS block based on the reported information from the UE, the serving radio network node may send a request (step 2) to the UE to retrieve the CGI from the target cell. Possibly, the UE also needs to be configured with a measurement gap. The UE detects and decodes also the RMSI from the target cell in order to retrieve the CGI (step 2.b). The CGI is stored and reported to the serving gNB (steps 3).

When non-CD-SSB signals are defined with a PCI different from the CD-SSB transmitted by the same radio network node, there is no explicit or implicit association between non-CD-SSB and CD-SSB. In this case, a UE detecting a non-CD-SSB cannot correctly determine from which radio network node the non-CD-SSB is transmitted from, i.e., to which CD-SSB (radio cell) the non-CD-SSB is associated to.

### SUMMARY

In the example in FIG. 2, each radio network node transmits a CD-SSB signal and multiple non-CD-SSB signals at different frequency locations. FIG. 2 illustrates three possible scenarios, one for each radio network node, representing different possible configurations of PCI for the non-CS-SSB signals, here represented by different filling patterns, compared to the corresponding configuration of the CD-SSB signal transmitted by the network node:
Network node-1: transmits two non-CD-SSBs configured with the same PCI value used in the CD-SSB signal configuration, i.e., PCI=23. In this case, the non-CD-SSB has a clear association to the CD-SSB.
Network node-2: transmits three non-CD-SSBs of which, two are configured with the same PCI value used in the CD-SSB signal configuration transmitted by the network node, i.e., PCI=5, and one non-CB-SSB is configured with a different PCI value, i.e., PCI=13.
Network node-3: transmits a CD-SSB signal configured with PCI=90 and two non-CD-SSB signals at different frequency locations both configured with PCI values different from the one used for the CD-SSB signal configuration, i.e., PCI=87 and PCI=108, respectively.

For network node-2 and network node-3, there are non-CD-SSB signals without a clear association to the corresponding CD-SSB signal. Without an association between non-CD-SSB and CD-SSB signal configurations, a UE detecting a non-CD-SSB with PCI different from the CD-SSB, as in the case of network node-2 and network node-3 in the example above, is unable to associated relevant system information, such as the system information blocks (SIB) and the master information block (MIB), with the non-CD-SSB signal. Thus, also unable to determine the proper network configuration to be used as well as to which network node for reporting radio measurements of the non-CS-SSB.

An object herein is to provide a mechanism to enable communication, e.g. handle or manage detection of system information from a radio network node, in an efficient manner in a wireless communications network.

According to an aspect the object is achieved, according to embodiments herein, by providing a method performed by a radio network node for handling communication, such as managing synchronization signals or performing SSBs, in a wireless communication network. The radio network node determines a first cell identity value for a non-CD synchronization signal, wherein the first cell identity value is determined as a function of a second cell identity value of a CD synchronization signal transmitted by the radio network node. The radio network node configures the non-CD synchronization signal based on said determined first cell identity value, and transmits the non-CD synchronization signal as configured. The radio network node may thus transmit a non-CD-SSB associated or configured with the first cell identity value, wherein the first cell identity value is associated with, e.g. being a function of, the second cell identity value of the CD-SSB transmitted by the radio network node.

According to another aspect the object is achieved, according to embodiments herein, by providing a method performed by a UE for handling communication, such as handling synchronization signals, e.g. enable detection of SI of a radio network node, from a radio network node in a wireless communication network. The UE receives a non-CD synchronization signal, and one or more CD synchronization signals. The UE decodes the non-CD synchronization signal to determine a first cell identity value associated to the non-CD synchronization signal, and decodes the one or more CD synchronization signals to determine one or more second cell identity values associated to the one or more CD synchronization signals. Furthermore, the UE determines whether the non-CD-synchronization signal is associated with at least one CD-synchronization signal, and thereby transmitted from a same radio network node, based on the first cell identity value and the one or more second cell identity values. Thus, the UE may receive, from the radio network node, a non-CD-SSB associated or configured with a first cell identity value, wherein the first cell identity value is associated with, e.g. being a function of, a second cell identity value of the CD-SSB transmitted by the radio network node. The UE then determines CD-SSB associated with the non-CD-SSB based on the first cell identity value being associated with the second cell identity value e.g. since the UE knows how the SSBs are associated for example via a function or similar.

According to yet another aspect of embodiments herein, the object is achieved by providing a UE configured to perform the method herein. The UE for handling synchronization signals from a radio network node in a wireless communication network. The UE is configured to receive a non-CD synchronization signal, and one or more CD synchronization signals. The UE is further configured to decode the non-CD synchronization signal to determine a first cell identity value associated to the non-CD synchronization signal, and to decode the one or more CD synchronization signal to determine one or more second cell identity values associated to the one or more CD synchronization signal. The UE is further configured to determine whether the non-CD-synchronization signal is associated with at least one CD-synchronization signal, and thereby transmitted from a same radio network node, based on the first cell identity value and the one or more second cell identity values.

According to still another aspect of embodiments herein, the object is achieved by providing a radio network node configured to perform the method herein. A radio network node for managing synchronization signal blocks in a wireless communication network is herein disclosed. The radio network node is configured to determine a first cell identity value for a non-CD synchronization signal, wherein the first cell identity value is determined as a function of a second cell identity value of a CD synchronization signal transmitted by the radio network node. The radio network node is further configured to configure the non-CD synchronization signal based on said determined first cell identity value; and to transmit the non-CD synchronization signal as configured.

It is furthermore provided herein a computer program product comprising instructions, which, when executed on at least one processor, cause the at least one processor to carry out the method above, as performed by the UE or the radio network node, respectively. It is additionally provided herein a computer-readable storage medium, having stored thereon a computer program product comprising instructions which, when executed on at least one processor, cause the at least one processor to carry out the method according to the method above, as performed by the UE or the radio network node, respectively.

Embodiments herein associate the cell ID value (i.e., the PCI) of e.g. a non-CD-SSB to the cell ID value of e.g. a CD-SSB, so that upon receiving and decoding the non-CD-SSB characterized by a PCI value different from the PCI value of CD-SSB, the UE can correctly associate the non-CD-SSB to the CD-SSB. This further allows the UE to associate to the non-CD-SSB signal to relevant system information obtained from the CD-SSB signal, such as SIB and MIB in the 3GPP LTE and 5G NR systems. Thus, the first cell ID value of the non-CD-SSB, and thus the non-CD-SSB, can be univocally associated with a CD-SSB. Choosing to determine the PCI value of a non-CD-SSB using the same Ng) value of a CD-SSB can considerably reduce the probability of misinterpreting the association between non-CD-SSB and CD-SSB, i.e., it is unlikely that a neighboring cell uses the same NJ′ value. Embodiments herein enable the radio network node to more efficiently control the performance of UEs, and to more efficiently utilize the spectrum available since misinterpretation is avoided.

### BRIEF DESCRIPTION OF THE DRAWINGS

Embodiments will now be described in more detail in relation to the enclosed drawings, in which:

FIG. 1 is a schematic illustration of a Synchronization Signal and PBCH Block (SSB) for 3GPP NR system;

FIG. 2 shows examples of CD-SSB signal and non-CD-SSB signal configurations;

FIG. 3 is a schematic overview depicting a wireless communications network according to embodiments herein;

FIG. 4A is a schematic flowchart depicting a method performed by a radio network node according to embodiments herein;

FIG. 4B is a schematic flowchart depicting a method performed by a radio network node according to embodiments herein;

FIGS. 5A-5D are disclosing non-CD-SSBs associated with CD-SSBs;

FIG. 6A is a schematic flowchart depicting a method performed by a UE according to embodiments herein;

FIG. 6B is a schematic flowchart depicting a method performed by a UE according to embodiments herein;

FIG. 7 is a block diagram depicting a UE according to embodiments herein;

FIG. 8 is a block diagram depicting a radio network node according to embodiments herein;

FIG. 9 is a telecommunication network connected via an intermediate network to a host computer in accordance with some embodiments;

FIG. 10 is a host computer communicating via a base station with a user equipment over a partially wireless connection in accordance with some embodiments;

FIG. 11 is methods implemented in a communication system including a host computer, a base station and a user equipment in accordance with some embodiments;

FIG. 12 is methods implemented in a communication system including a host computer, a base station and a user equipment in accordance with some embodiments;

FIG. 13 is methods implemented in a communication system including a host computer, a base station and a user equipment in accordance with some embodiments; and

FIG. 14 is methods implemented in a communication system including a host computer, a base station and a user equipment in accordance with some embodiments.

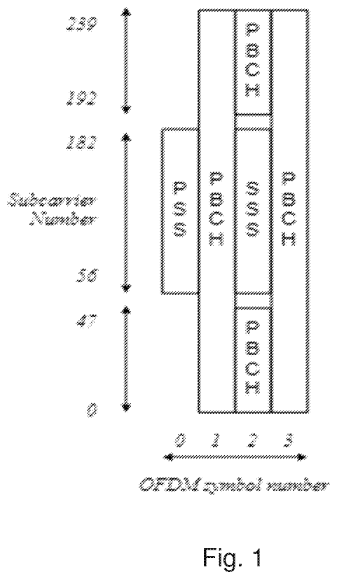

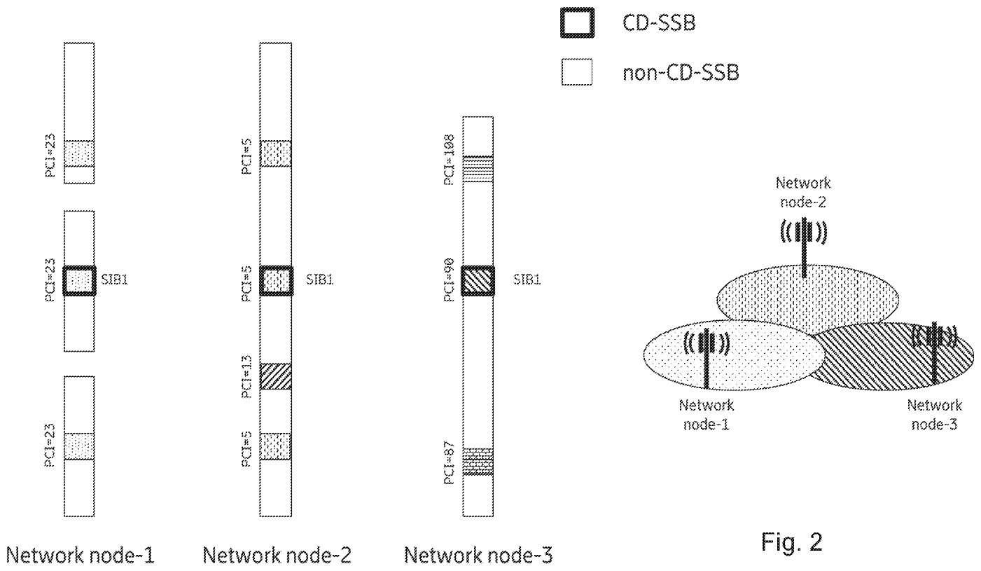

### DETAILED DESCRIPTION

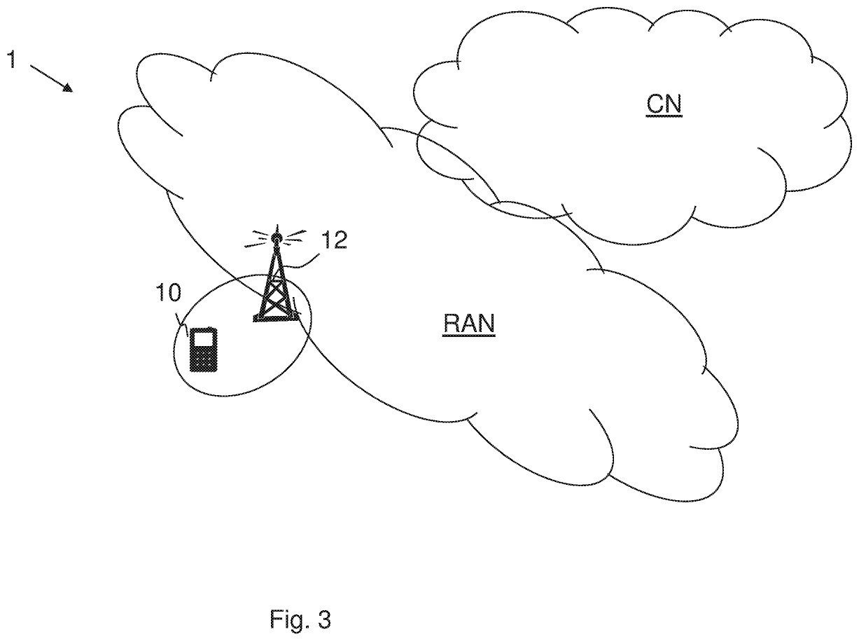

Embodiments herein relate to wireless communications networks in general. FIG. 3 is a schematic overview depicting a wireless communications network 1. The wireless communications network 1 comprises one or more RANs and one or more CNs. The wireless communications network 1 may use one or a number of different technologies. Embodiments herein relate to recent technology trends that are of particular interest in a New Radio (NR) context, however, embodiments are also applicable in further development of existing wireless communications systems such as e.g. LTE or Wideband Code Division Multiple Access (WCDMA).

In the wireless communications network 1, a wireless device exemplified herein as a UE 10 such as a mobile station, a non-access point (non-AP) STA, a STA, a user equipment and/or a wireless terminal, is comprised communicating via e.g. one or more Access Networks (AN), e.g. RAN, to one or more core networks (CN). It should be understood by the skilled in the art that “wireless device” is a non-limiting term which means any terminal, wireless communications terminal, user equipment, NB-IoT device, Machine Type Communication (MTC) device, Device to Device (D2D) terminal, or node e.g. smart phone, laptop, mobile phone, sensor, relay, mobile tablets or even a small base station capable of communicating using radio communication with a radio network node within an area served by the radio network node.

The wireless communications network 1 comprises a radio network node 12 providing radio coverage over a geographical area, a service area, of a radio access technology (RAT), such as NR, LTE, or similar. The radio network node 12 may be a transmission and reception point such as an access node, an access controller, a base station, e.g. a radio base station such as a gNodeB (gNB), an evolved Node B (eNB, eNode B), a NodeB, a base transceiver station, a radio remote unit, an Access Point Base Station, a base station router, a Wireless Local Area Network (WLAN) access point or an Access Point Station (AP STA), a transmission arrangement of a radio base station, a stand-alone access point or any other network unit or node capable of communicating with a wireless device within the area served by the radio network node depending e.g. on the first radio access technology and terminology used.

According to embodiments herein the radio network node 12 transmits a non-CD-synchronization signal, e.g. a non-CD-SSB, associated or configured with a first cell identity value, wherein the first cell identity value is associated with, e.g. being a function of, a second cell identity value of the CD-synchronization signal, e.g. a CD-SSB, transmitted by the radio network node 12. The UE 10 receives the non-CD-synchronization signal associated or configured with the first cell identity value. The UE 10 may then determine that the CD-SSB is associated with the non-CD-SSB based on the first cell identity value since the first cell identity value is associated with the second cell identity value.

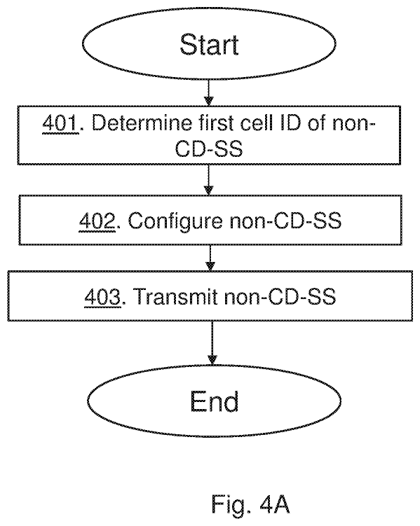

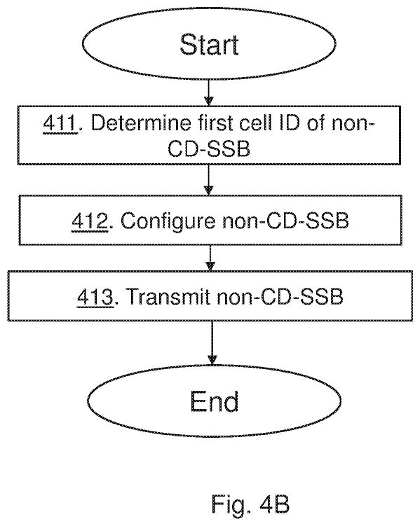

The method action performed by the radio network node 12 for managing synchronization signal blocks in the wireless communications network 1 according to embodiments herein will now be described with reference to a flowchart depicted in FIG. 4A.

Action 401. The radio network node 12 determines the first cell identity value for non-CD synchronization signal, wherein the first cell identity value is determined as a function of the second cell identity value of the CD synchronization signal transmitted by the radio network node 12. A synchronization signal may be exemplified as any signal or reference signal used for synchronization. The non-CD synchronization signal may comprises a non-CD-SSB and the CD synchronization signal may comprise a CD-SSB. The first cell identity value may comprise a first physical cell identity value and the second cell identity value may comprise a second physical cell identity value. The radio network node 12 may determine the first cell identity value by computing the first cell identity value based on a cyclic shift associated to the CD-synchronization signal. The radio network node 12 may determine the first cell identity value, N_{ID}^{Cell non-CD-SS}, for the non-CD synchronization signal by determining N_{ID}^{Cell non-CD-SS}=3N_{ID}^{(1) non-CD-SS}+N_{ID}^{(2) non-CD-SS} wherein N_{ID}^{(1) non-CD-SS} is an integer, e.g. encoded in a secondary synchronization signal transmission, for the non-CD synchronization signal and N_{ID}^{(2) non-CD-SS} is an integer, e.g. encoded in the primary synchronization signal transmission, for the non-CD synchronization signal; and wherein N_{ID}^{(1) non-CD-SS} is computed based on a cyclic shift of sum between a value N_{ID}^{(1) CD-SS} of the CD synchronization signal and an offset value Δ⁽¹⁾; wherein N_{ID}^{(1) CD-SS} is an integer, e.g. encoded in a secondary synchronization signal transmission, for the CD synchronization signal. The offset value Δ⁽¹⁾ may be a positive or negative integer. The value N_{ID}^{(2) non-CD-SS} may be constrained to be either the same as value, or a different value, from the value N_{ID}^{(2) CD-SS} used in the associated CD-SSB.

Note: a case that is excluded is where this operation would result into
N_{ID}^{Cell non-CD-SS}=N_{ID}^{Cell CD-SS} which occurs for Δ⁽¹⁾=0, i.e., N_{ID}^{(1) non-CD-SS}=N_{ID}^{(1) CD-SS} and N_{ID}^{(2) non-CD-SS}=N_{ID}^{(2) CD-SS}.

The radio network node 12 may determine the first cell identity value, N_{ID}^{Cell non-CD-SS}, for the non-CD synchronization signal by determining N_{ID}^{(1) non-CD-SS} as

$${N}_{ID}^{( 1 ) non \text{-} CD \text{-} SS} = {\{ {N}_{ID}^{( 1 ) CD \text{-} SS} + {Δ}^{( 1 )} \}}_{0}^{N} = \{ \begin{matrix}{N}_{ID}^{( 1 ) CD \text{-} SS} + {Δ}^{( 1 )} & if {N}_{ID}^{( 1 ) CD \text{-} SS} + {Δ}^{( 1 )} \leq N \\ {N}_{ID}^{( 1 ) CD \text{-} SS} + {Δ}^{( 1 )} - N - 1 & if {N}_{ID}^{( 1 ) CD \text{-} SS} + {Δ}^{( 1 )} > N\end{matrix}$$

where the notation {x}₀^{N} a cyclic shift operation on an argument x which projects x in the interval of integers {0, N}.

The radio network node 12 may determine the first cell identity value, N_{ID}^{Cell non-CD-SS}, for the non-CD synchronization signal by determining N_{ID}^{(1) non-CD-SS} as N_{ID}^{(1) non-CD-SS}={N_{ID}^{(1) CD-SS}−Δ⁽¹⁾}₀^{N}.

The integer value N used in the cyclic shift operation N_{ID}^{(1) non-CD-SS}={N_{ID}^{(1) CD-SS}±Δ⁽¹⁾} may be a maximum range of the parameter N_{ID}^{(1) CD-SS} used for the CD- synchronization signal.

The offset value Δ⁽¹⁾ may be strictly greater than zero or strictly less than zero, and the integer N_{ID}^{(2) non-CD-SS} used to determine the first cell identity value N_{ID}^{Cell non-CD-SS} may be chosen as either

N_{ID}^{(2)non-CD-SS}=N_{ID}^{(2)CD-SS} or
N_{ID}^{(2) non-CD-SS}≠N_{ID}^{(2) CD-SS}, where N_{ID}^{(2) CD-SS} is a second integer for the CD-synchronization signal. Thus, N_{ID}^{(2) non-CD-SS} may be equal or different from N_{ID}^{(2) CD-SS}.

The offset value Δ⁽¹⁾ may be equal to zero, and then the N_{ID}^{(2) non-CD-SS} may be chosen as

N_{ID}^{(2)non-CD-SS}≠N_{ID}^{(2)CD-SS}

The first cell identity value, N_{ID}^{Cell non-CD-SS}, for the non-CD-synchronization signal may be determined as a cyclic shift of the second cell identity value of the corresponding CD-synchronization signal according to:

N_{ID}^{Cell non-CD-SS}={N_{ID}^{Cell CD-SS}±Δ}₀^{N}

The integer value N used in the cyclic shift operation N_{ID}^{Cell non-CD-SS}={N_{ID}^{Cell CD-SS}±Δ}₀^{N} may be a maximum range of the parameter N_{ID}^{Cell CD-SS} used for the CD synchronization signal.

The radio network node 12 may determine the first cell identity value, N_{ID}^{Cell non-CD-SS}, for the non-CD synchronization signal by determining the first cell identity value N_{ID}^{Cell non-CD-SS}=3N_{ID}^{(1) non-CD-SS}+N_{ID}^{(2) non-CD-SS} wherein N_{ID}^{(1) non-CD-SS} may be constrained to be equal to the value N_{ID}^{(1) CD-SS} of the corresponding CD-synchronization signal and N_{ID}^{(2) non-CD-SS} is different from N_{ID}^{(2) CD-SS}.

The radio network node 12 may determine the first cell identity value, N_{ID}^{Cell non-CD-SS}, for the non-CD synchronization signal by determining the first cell identity value as N_{ID}^{Cell}=3N_{ID}^{(1) non-CD-SS}+N_{ID}^{(2) non-CD-SS} wherein N_{ID}^{(2) non-CD-SS} is constrained to be the same as the N_{ID}^{(2) CD-SS} value of the corresponding CD-synchronization signal and N_{ID}^{(1) non-CD-SS} is different.

Action 402. The radio network node 12 configures the non-CD synchronization signal based on said determined first cell identity value. The radio network node may configure the non-CD synchronization signal by configuring K non-CD synchronization signals associated with a single CD-synchronization signal by configuring the first cell identity value for each non-CD synchronization signal, N_{ID}^{(1) non-CD-SS}, with different shift values Δₖ⁽¹⁾ associated to the CD-synchronization signal as:

N_{ID}^{(1)non-CD-SS}={N_{ID}^{(1)CD-SS}+Δₖ⁽¹⁾}₀^{N} k=1, . . . ,K.

Action 403. The radio network node 12 transmits the non-CD synchronization signal as configured. The non-CD synchronization signal and the CD synchronization signal may be transmitted at different frequency locations.

The method action performed by the radio network node 12 for handling communication, e.g. handle or manage synchronization or system information (SI) transmission in an efficient manner in the wireless communications network 1 according to embodiments herein will now be described with reference to a flowchart depicted in FIG. 4B.

Action 411. The radio network node 12 may determine the first cell identity value such as PCI value for the non-CD-SSB as a function of the second cell identity value such as the second PCI value of the CD-SSB transmitted by the radio network node 12. The first cell identity value may be computed based on the cyclic shift associated to the CD-SSB. E.g. the radio network node 12 may determine the first PCI value for the non-CD-SSB as N_{ID}^{Cell non-CD-SSB}=3N_{ID}^{(1) non-CD-SSB}+N_{ID}^{(2) non-CD-SSB} wherein N_{ID}^{(1) non-CD-SSB} is computed based on a cyclic shift of a sum between the second PCI value N_{ID}^{(1) CD-SSB} of the associated CD-SSB and the offset value Δ⁽¹⁾
The value N_{ID}^{(2) non-CD-SSB} may be constrained to be either the same as or a different from the value N_{ID}^{(2) CD-SSB} used in the associated CD-SSB.
Note. Need to exclude the special case wherein this operation would result into N_{ID}^{Cell non-CD-SSB}=N_{ID}^{Cell CD-SSB} which occurs for Δ⁽¹⁾=0 (i.e., N_{ID}^{(1) non-CD-SSB}=N_{ID}^{(1) CD-SSB}) and N_{ID}^{(2) non-CD-SSB}=N_{ID}^{(23) CD-SSB}.

Thus,

$${N}_{ID}^{( 1 ) non \text{-} CD \text{-} SSB} = {\{ {N}_{ID}^{( 1 ) CD \text{-} SSB} + {Δ}^{( 1 )} \}}_{0}^{N} = \{ \begin{matrix}{N}_{ID}^{( 1 ) CD \text{-} SSB} + {Δ}^{( 1 )} & if {N}_{ID}^{( 1 ) CD \text{-} SSB} + {Δ}^{( 1 )} \leq N \\ {N}_{ID}^{( 1 ) CD \text{-} SSB} + {Δ}^{( 1 )} - N - 1 & if {N}_{ID}^{( 1 ) CD \text{-} SSB} + {Δ}^{( 1 )} > N\end{matrix}$$

where the notation {x}₀^{N} denotes a projection of x in the interval of integers {0, . . . , N} If Δ⁽¹⁾ is strictly grater than zero, the parameter N_{ID}^{Cell non-CD-SSB} can be chosen as either

N_{ID}^{(2)non-CD-SSB}=N_{ID}^{(2)CD-SSB} or

N_{ID}^{(2)non-CD-SSB}≠N_{ID}^{(2)CD-SS}

If Δ⁽¹⁾ is equal to zero, the parameter N_{ID}^{(2) non-CD-SSB} shall be chosen as

N_{ID}^{(2)non-CD-SSB}≠N_{ID}^{(2)CD-SS}

The cyclic shift operation may insure that the resulting value of N_{ID}^{(1) non-CD-SSB} remains in the same range of values defined for N_{ID}^{(1) CD-SSB}.

Additionally or alternatively, the parameter N_{ID}^{(1) non-CD-SSB} may be determined with a negative cyclic shift operation, i.e.

N_{ID}^{(1)non-CD-SSB}={N_{ID}^{(1)CD-SSB}−Δ⁽¹⁾}₀^{N}.

Additionally or alternatively, the radio network node 12 may determine the first PCI value for the non-CD-SSB N_{ID}^{Cell non-CD-SSB} as the cyclic shift of the second PCI value of the corresponding cell-defining SSB, i.e.

N_{ID}^{Cell non-CD-SSB}={N_{ID}^{Cell CD-SSB}+Δ}₀^{N}

In some scenarios, the radio network node 12 may determine the first PCI value for the non-CD-SSB as N_{ID}^{Cell non-CD-SSB}=3N_{ID}^{(1) non-CD-SSB}+N_{ID}^{(2) non-CD-SSB} wherein N_{ID}^{(1) non-CD-SSB} is constrained to be equal to the value N_{ID}^{(1) CD-SSB} of the CD-SSB and N_{ID}^{(2) non-CD-SSB} is different from N_{ID}^{(2) CD-SSB}; and/or

the radio network node 12 may determine the first PCI value for the non-CD-SSB as N_{ID}^{Cell}=3N_{ID}^{(1) non-CD-SSB}+N_{ID}^{(2) non-CD-SSB} wherein N_{ID}^{(2) non-CD-SSB} is constrained to be the same as the N_{ID}^{(2) CD-SSB} value of the CD-SSB and N_{ID}^{(1) non-CD-SSB} is different. This is an example of action 401 in FIG. 4A.

Action 412. The radio network node 12 may further configure the non-CD-SSB signal based on said determined first cell identity value. Additionally or alternatively, the radio network node may configure K non-CD-SSB associated with a single CD-SSB by configuring N_{ID}^{(1) non-CD-SSB} with different shift values Δₖ⁽¹⁾ as:

N_{ID}^{(1)non-CD-SSB}={N_{ID,k}^{(1)CD-SSB}+Δₖ⁽¹⁾}₀^{N}k=1, . . . ,K

This is an example of action 402 in FIG. 4A.

Action 413. The radio network node 12 transmits the non-CD-SSB as configured i.e. according to said configuration. Thus, the radio network node 12 transmits the non-CD-SSB associated to the first cell identity value, wherein the first cell identity value is associated with e.g. via a function of the second cell identity value of the CD-SSB transmitted by the radio network node 12. This is an example of action 403 in FIG. 4A.

Embodiments herein disclose a method executed by the radio network node 12 to associate the configuration of a non-CD-SSB signal to the configuration of a CD-SSB signal, both transmitted by the radio network node 12.

Without loss of generality, hereafter it is referred to nomenclature and notation used by the 3GPP LTE and the 3GPP 5G NR family of standards, wherein the cell identity such as physical cell identity is defined as N_{ID}^{Cell}=3N_{ID}⁽¹⁾+N_{ID}⁽²⁾, where N_{ID}⁽¹⁾ is an integer in the range {0, 1, . . . , 335} encoded in the SSSB transmission and N_{ID}⁽²⁾ is an integer offset in the range {0, 1, 2} encoded in the PSSB transmission. Therefore let N_{ID}^{Cell CD-SSB}=3N_{ID}^{(1) CD-SSB}+N_{ID}^{(2) CD-SSB} denote the second PCI value for a CD-SSB signal and as N_{ID}^{Cell non-CD-SSB}=3N_{ID}^{(1) non-CD-SSB}+N_{ID}^{(2) non-CD-SSB} denote the first PCI value for a non-CD-SSB signal.

One method to realize an association between the configuration of a non-CD-SSB signal and the configuration of a CD-SSB signal is to compute the first PCI N_{ID}^{Cell non-CD-SSB} used for the non-CD-SSB as a function of the PCI N_{ID}^{Cell CD-SSB} used for the CD-SSB transmitted by the same radio network node, i.e. N_{ID}^{Cell non-CD-SSB}=∫(N_{ID}^{Cell CD-SSB}).

In one embodiment, the first PCI N_{ID}^{Cell non-CD-SSB} for the non-CD-SSB is configured by constraining the parameter N_{ID}^{(1) non-CD-SSB} to be a function of the second PCI N_{ID}^{(1) CD-SSB} of the CD-SSB signal, i.e. N_{ID}^{(1) non-CD-SSB}=ƒ(N_{ID}^{(1) CD-SSB}). In this case, the offset value N_{ID}^{(2) non-CD-SSB} could be either constrained to be the same as the offset value N_{ID}^{(2) CD-SSB} of the CD-SSB or it could be configured to a different value as long as the resulting PCI value N_{ID}^{Cell non-CD-SSB} of the non-CD-SSB signal is not equal to the PCI value N_{ID}^{Cell CD-SSB} of the CD-SSB signal.

One example to realize N_{ID}^{(1) non-CD-SSB}=∫(N_{ID}^{(1) CD-SSB}) is by determining N_{ID}^{(1) non-CD-SSB} as a cyclic shift of the sum of the second PCI N_{ID}^{(1) CD-SSB} and shift value Δ⁽¹⁾, with the cyclic shift operation defined so that the resulting value of N_{ID}^{(1) non-CD-SSB} remains in the same range of values defined for N_{ID}^{(1) CD-SSB}. To this end, N_{ID}^{(1) non-CD-SSB} may be determined as

$${N}_{ID}^{( 1 ) non \text{-} CD \text{-} SSB} = {\{ {N}_{ID}^{( 1 ) CD \text{-} SSB} + {Δ}^{( 1 )} \}}_{0}^{N} = \{ \begin{matrix}{N}_{ID}^{( 1 ) CD \text{-} SSB} + {Δ}^{( 1 )} & if {N}_{ID}^{( 1 ) CD \text{-} SSB} + {Δ}^{( 1 )} \leq N \\ {N}_{ID}^{( 1 ) CD \text{-} SSB} + {Δ}^{( 1 )} - N - 1 & if {N}_{ID}^{( 1 ) CD \text{-} SSB} + {Δ}^{( 1 )} > N\end{matrix}$$

where the notation {x}₀^{N} denotes a projection of x in the interval of integers {0, . . . , N}, and Δ⁽¹⁾ is a either a positive or a negative integer number. In other words, if x′={N+1}₀^{N}=0, x′={N+2}₀^{N}=1, etc. For instance, in the case of the 3GPP LTE or 5G NR it is desirable to keep N_{ID}^{(1) non-CD-SSN} in the range {0, 1, . . . 335}, hence the upper bound parameter of the cyclic shift operation would be N=335. Furthermore, it is clear to the person skilled in the art, that an equivalent result can be obtained with a negative cyclic shift operation, i.e.

N_{ID}^{(1)non-CD-SSB}={N_{ID}^{(1)CD-SSB}−Δ⁽¹⁾}₀^{N}.

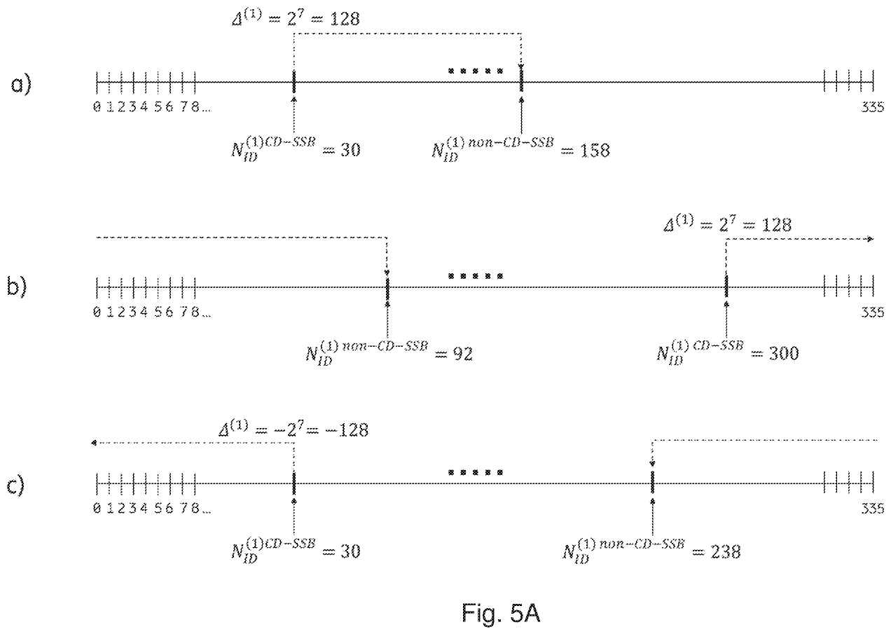

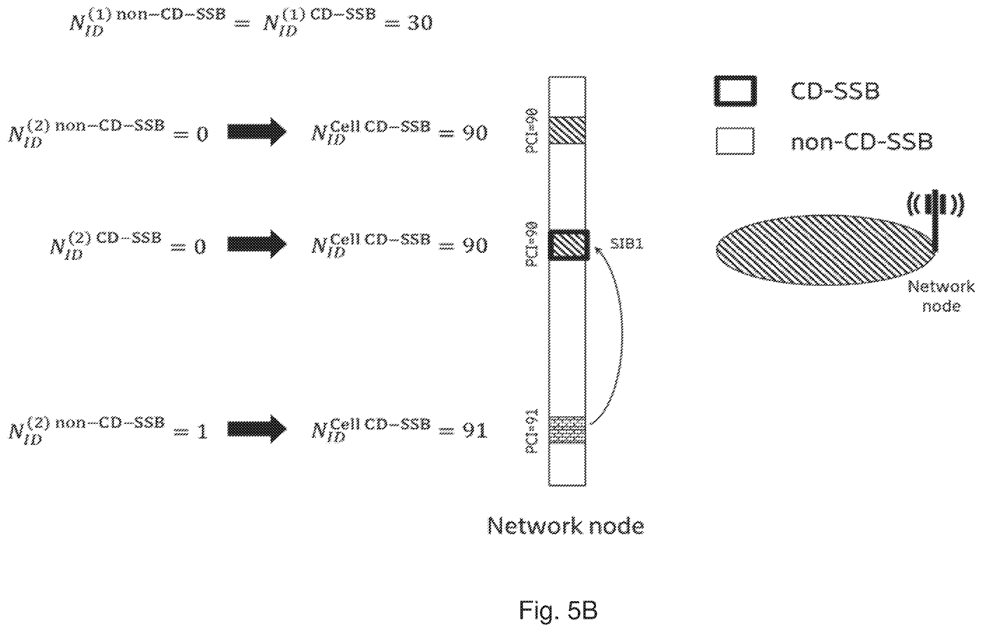

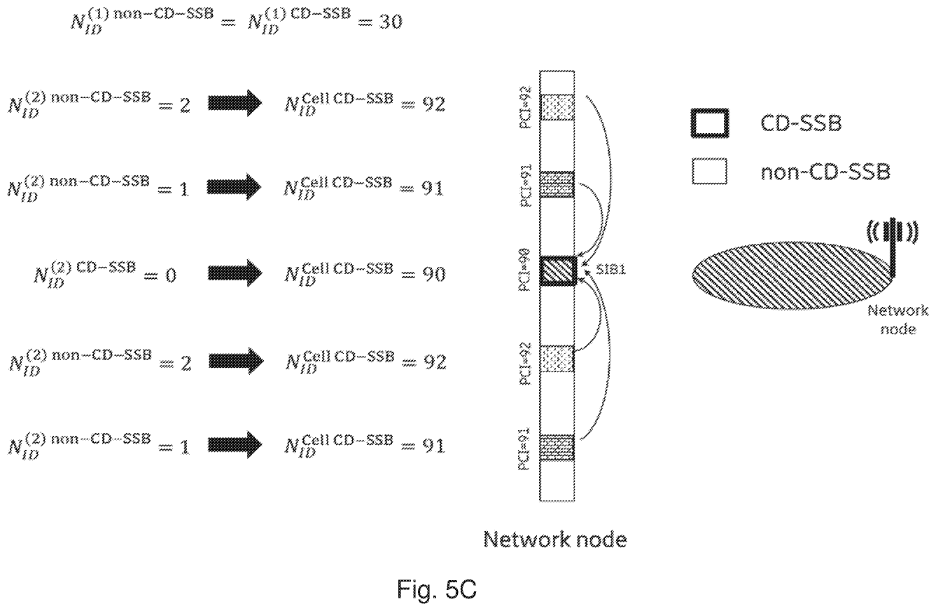

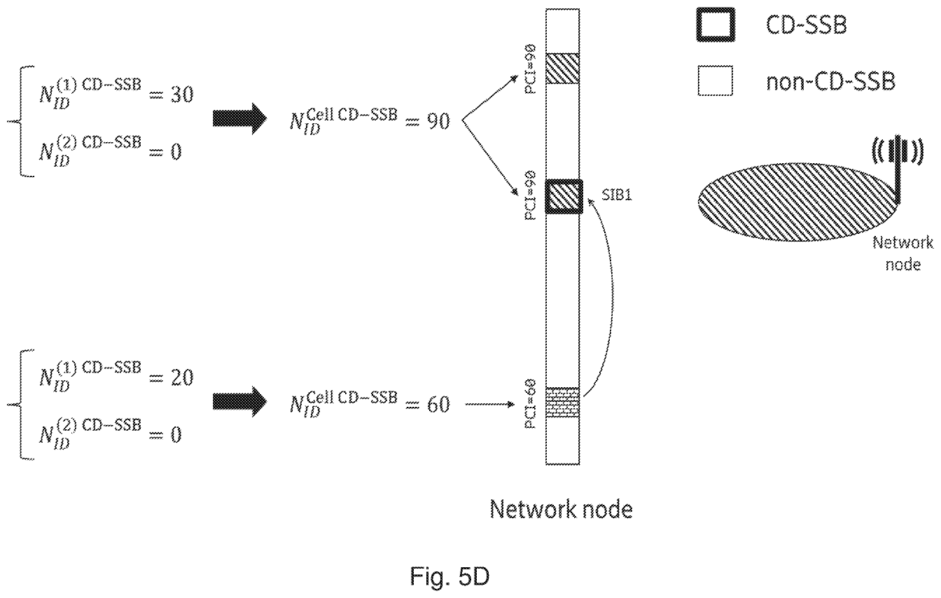

FIG. 5A shows an example of how the parameter N_{ID}^{(1) non-CD-SSB} may be determined as a cyclic shift of the sum of the parameter N_{ID}^{(1) CD-SSB} and shift value Δ⁽¹⁾. FIG. 5A shows examples of cyclic shift operations assuming an interval of number between zero and N=335 for the parameters N_{ID}^{(1) non-CD-SSB} and N_{ID}^{(1) CD-SSB} as specified by the 3GPP LTE and NR standards. In a), assume that N_{ID}^{(1) CD-SSB}=30 and Δ⁽¹⁾=128, hence N_{ID}^{(1) non-CD-SSB}=158 is the result of the pure sum of N_{ID}^{(1) CD-SSB} and Δ⁽¹⁾. In b), assume that N_{ID}^{(1) CD-SSB}=300 and Δ⁽¹⁾=128, thus the cyclic shift operation gives N_{ID}^{(1) non-CD-SSB}=92. In c) assume that N_{ID}^{(1) CD-SSB}=30 and Δ⁽¹⁾=128, thus the cyclic shift in the negative direction gives N_{ID}^{(1) non-CD-SSB}=238

In one alternative implementation of the method, the radio network node 12 may therefore configure multiple non-CD-SSB signals to be associated to the same CD-SSB signal by configuring different values N_{ID}^{(1) non-CD-SSB} as a cyclic shift of N_{ID}^{(1) CD-SSB} with different shift values Δ⁽¹⁾. For instance, the radio network node 12 may configure a number K non-CD-SSB associated with a single CD-SSB by configuring N_{ID}^{(1) non-CD-SSB} with different shift values Δₖ⁽¹⁾ as:

N_{ID}^{(1)non-CD-SSB}={N_{ID,k}^{(1)CD-SSB}+Δₖ⁽¹⁾}₀^{N} k=1, . . . ,K

The cyclic shift value Δ⁽¹⁾ could be known a priori to the UE 10. In one example, the cyclic shift and Δ⁽¹⁾ could be chosen in a set of values {i₁, i₂, . . . , i_{M}} known a priori to the UE 10, where each value iₘ in the set is either a positive or a negative integer number. For example, the values iₘ could be chosen as iₘ=α^{m} or iₘ=−α^{m}, for m=1, . . . , M and α being a constant. Different values of the constant α or the upper limit M can be chosen. For instance, iₘ=±2^{m}, iₘ=±3^{m} etc.

Special Cases:

In one embodiment, the first PCI N_{ID}^{Cell non-CD-SSB} for a non-CD-SSB is computed by constraining the parameter N_{ID}^{(1) non-CD-SSB} to be equal to the parameter N_{ID}^{(1) CD-SSB} of a CD-SSB, i.e. N_{ID}^{(1) non-CD-SSB}=N_{ID}^{(1) CD-SSB}. This is equivalent to use a cyclic shift operation with shift value Δ⁽¹⁾=0. In this case, the parameter N_{ID}^{(2) non-CD-SSB} is configured to be different from N_{ID}^{(2) CD-SSB} (in mathematical form this is expressed as N_{ID}^{(2) non-CD-SSB}≠N_{ID}^{(2) CD-SSB}). Notice that if also N_{ID}^{(2) non-CD-SSB}≠N_{ID}^{(2) CD-SSB} then the PCI of the non-CD-SSB would be equal to the PCI of the CD-SSB. In summary:
the radio network node configures the non-CD-SSB using N_{ID}^{(1) non-CD-SSB}=N_{ID}^{(1) CD-SSB} and N_{ID}^{(2) non-CD-SSB}≠N_{ID}^{(2) CD-SSB} with PCI defined by parameters N_{ID}^{(1) CD-SSB} and N_{ID}^{(2) CD-SSB}.

In the 3GPP LTE and 5G NR systems, the value N_{ID}^{(1) CD-SSB} ranges in the set {0, 1, . . . , 335}, the constraint N_{ID}^{(1) non-CD-SSB}=N_{ID}^{(1) CD-SSB} enables to create an association between the configuration of a non-CD-SSB signal and the configuration of a CD-SSB signal while insuring that the first PCI of the non-CD-SSB signal differs from the second PCI value used in neighboring cells with sufficiently high probability. Since the values N_{ID}^{(2) CD-SSB} ranges in the interval {0, 1, 2}, the constraint that N_{ID}^{(2) non-CD-SSB}≠N_{ID}^{(2) CD-SSB} implies that there are at most two PCI values that can be used to configure a non-CD-SSB signal and provide an univocal association to the PCI of a CD-SSB) while being different from it. This has the advantage of considerably reducing the probability of misinterpreting the association between non-CD-SSB signal and CD-SSB signal, i.e., it is unlikely that two neighboring cell uses the same N_{ID}^{(1) CD-SSB} value to configure their respective CD-SSB signals

FIG. 5B is an illustration of one example where a non-CD-SSB is configured with N_{ID}^{(1) non-CD-SSB}=N_{ID}^{(1) CD-SSB} but uses different offset value compared to the CD-SSB signal

FIG. 5B shows an illustration of an embodiment of the method wherein a network node transmits two non-CD-SSB: One non-CD-SSB is configured with the same PCI value of the CD-SSB; the second non-CD-SSB is configured according to the method with N_{ID}^{(1) non-CD-SSB}=N_{ID}^{(1) CD-SSB} (in this example N_{ID}^{(1) non-CD-SSB}=N_{ID}^{(1) CD-SSB}=30) but different offset, i.e N_{ID}^{(2) non-CD-SSB}=1 while N_{ID}^{(2) CD-SSB}=0. Although the PCI values used in the configuration of CD-SSB and non-CD-SSB signals are different, a user device decoding the CD-SSB and non-CD-SSB signals would be able to associated the non-CD-SSB signal to the proper CD-SSB signal.

The availability of two PCI values that can be univocally associated to a third PCI value can be exploited in the case of multiple non-CD-SSB signals being transmitted in different frequency location of a frequency carrier. For instance, different non-CD-SSB signals at different frequency location can be configured to have a specific allocation pattern of the two PCI values. In FIG. 5C, for instance, non-CD-SSB signals are transmitted by alternating (in frequency domain) the allocation of the two PCI values that provide the desired association to the CD-SSB signal.

FIG. 5C is an example of non-CD-SSB signals in different frequency location of a frequency carrier configured with an alternating pattern of offset values N_{ID}^{(2) non-CD-SSB} as described in one embodiment.

In one embodiment, the first PCI N_{ID}^{Cell non-CD-SSB} for the non-CD-SSB is computed by constraining the parameter N_{ID}^{(2) non-CD-SSB} to be equal to the parameter N_{ID}^{(2) CD-SSB} of a CD-SSB, i.e. N_{ID}^{(2) non-CD-SSB}=N_{ID}^{(2) CD-SSB} while the parameter N_{ID}^{(1) non-CD-SSB} is configured to different from N_{ID}^{(1) CD-SSB} (in mathematical form this is expressed as N_{ID}^{(1) non-CD-SSB}≠N_{ID}^{(1) CD-SSB}), e.g. based on a cyclic shift operation with shift value Δ⁽¹⁾≠0. In this case, the association of the non-CD-SSB signal to the CD-SSB signal is obtained by a constraining both values N_{ID}^{(1) non-CD-SSB} and N_{ID}^{(2) non-CD-SSB} of the non-CD-SSB signal to be dependent on the corresponding values N_{ID}^{(1) CD-SSB} and N_{ID}^{(2) CD-SSB} respectively, of the CD-SSB signal. In summary:
The radio network node 12 configures the first PCI of a non-CD-SSB using N_{ID}^{(2) non-CD-SSB}=N_{ID}^{(2) CD-SSB} and N_{ID}^{(1) non-CD-SSB}≠N_{ID}^{(1) CD-SSB} for a given CD-SSB with PCI defined by parameters N_{ID}^{(1) CD-SSB} and N_{ID}^{(2) CD-SS}

While the general method has the advantage of enabling a wide number of PCI values to be available for the configuration of a non-CD-SSB in association with a CD-SSB signal, the additional constraint N_{ID}^{(2) non-CD-SSB}=N_{ID}^{(2) CD-SSB} has the advantage to strengthen the association to the CD-SSB signal, at the cost of reducing the number of configurable PCI values. For instance, with the current 3GPP LTE and 5G NR systems, the method allows to configure a non-CD-SSB to be associated to a CD-SSB signal by choosing among 335 possible values for the parameter N_{ID}^{(1) non-CD-SSB}, for a given N_{ID}^{(1) CD-SSB} used in the configuration of the CD-SSB signal to which it is desired to associate the non-CD-SSB with.

FIG. 5D is an illustration of one example where a non-CD-SSB is configured with N_{ID}^{(1) non-CD-SSB}=N_{ID}^{(1) CD-SSB} but uses different N_{ID}^{(1) non-CD-SSB} offset value compared to the CD-SSB signal. The parameter N_{ID}^{(1) non-CD-SSB} could be configured with a cyclic shift operation w.r.t. N_{ID}^{(1) CD-SSB} with a cyclic shift offset Δ⁽¹⁾≠0 if the desired configuration requires N_{ID}^{Cell non-CD-SSB}≠N_{ID}^{Cell CD-SSB}.

FIG. 5D shows an illustration of an embodiment of the method wherein a radio network node transmits two non-CD-SSB: One non-CD-SSB is configured with the same PCI value of the CD-SSB; the second non-CD-SSB is configured according to the method with different seeds number, i.e. N_{ID}^{(1) CD-SSB}=30 while N_{ID}^{(1) non-CD-SSB}=20 but with the same offset value N_{ID}^{(2) non-CD-SSB}=N_{ID}^{(2) CD-SSB} (in this example N_{ID}^{(2) non-CD-SSB}=N_{ID}^{(2) CD-SSB}=0). Although the PCI values used in the configuration of CD-SSB and non-CD-SSB signals are different, the UE 10 decoding the CD-SSB and non-CD-SSB signals would be able to associate the non-CD-SSB signal to the proper CD-SSB signal (if no neighboring network node use the same offset in the configuration of the respective CD-SSB signals).

In one solution, the radio network node 12 may determine the first PCI value for a non-CD-SSB N_{ID}^{Cell non-CD-SSB} based on as a cyclic shift of the sum between the second PCI value of the corresponding cell-defining SSB and a shift value Δ, i.e.

N_{ID}^{Cell non-CD-SSB}={N_{ID}^{Cell CD-SSB}+Δ}₀^{N}

The shift value Δ can be either positive or negative, thereby resulting in a positive or negative cyclic shift. It can be noticed that if the PCI value N_{ID}^{Cell} for both CD-SSB and non-CD-SSB is defined based on the LTE NR equation N_{ID}^{Cell}=3N_{ID}⁽¹⁾+N_{ID}⁽²⁾ as previously described, it is clear to the skilled reader that this method can be equivalently rewritten in terms of cyclic shift value Δ⁽¹⁾ applied to the parameter N_{ID}⁽¹⁾.

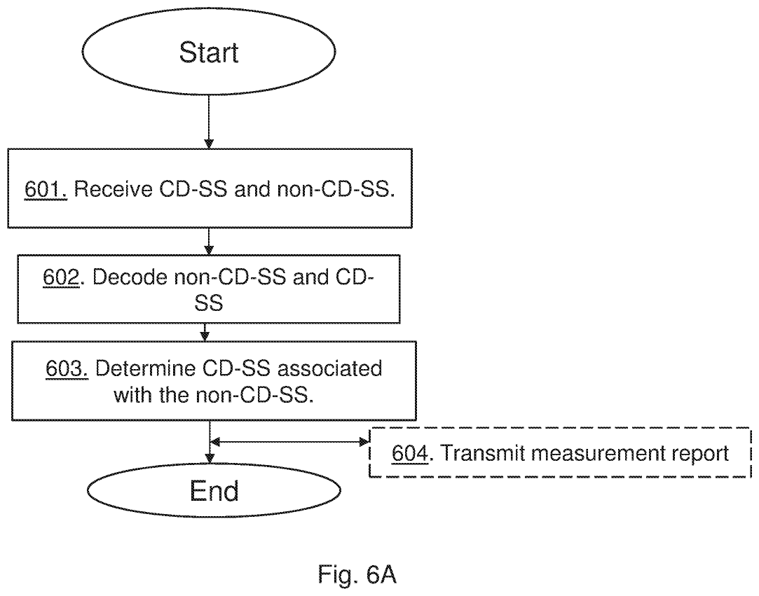

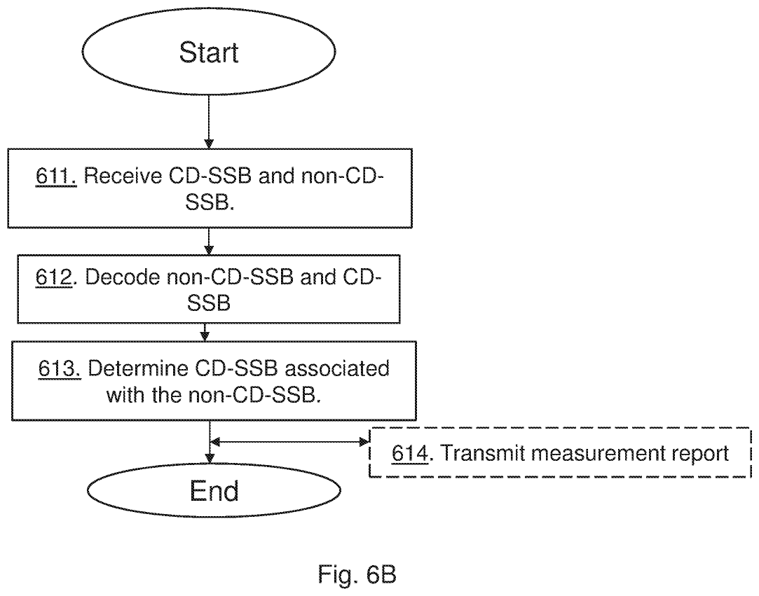

The method actions performed by the UE 10 for handling synchronization signals, from the radio network node 12 in the wireless communication network e.g. for handling detection of SI from the radio network node 12 in the wireless communication network 1 according to embodiments herein will now be described with reference to a flowchart depicted in FIG. 6A.

Action 601. The UE 10 receives the non-CD synchronization signal, and the one or more CD synchronization signals. E.g. receive the CD synchronization signal transmitted by the radio network node 12 and the non-CD synchronization signal, associated to the first cell identity value. The first cell identity value may be determined as the function of the second cell identity value of the CD synchronization signal transmitted by the radio network node 12. The UE 10 may receive the CD-SSB and the non-CD-SSB signals at different frequency locations. Non-CD synchronization signal may comprise a non-CD-SSB, and the CD synchronization signal may comprise a CD-SSB.

Action 602. The UE 10 further decodes the non-CD synchronization signal to determine the first cell identity value associated to the non-CD synchronization signal, and decodes the one or more CD synchronization signals to determine one or more second cell identity values associated to the one or more CD synchronization signals. Thus, the UE 10 may decode synchronization signals of the CD synchronization signal and the non-CD synchronization signal and may determine corresponding cell identity values. The first cell identity value may comprise the first physical cell identity value and the second cell identity value may comprise the second physical cell identity value. The first cell identity value, N_{ID}^{Cell non-CD-SS}, for the non-CD synchronization signal may be determined based on N_{ID}^{Cell non-CD-SS} as N_{ID}^{(1)non-CD-SS}={N_{ID}^{(1) CD-SS}+Δ⁽¹⁾}₀^{N}. The first cell identity value, N_{ID}^{Cell non-CD-SS}, for the non-CD-synchronization signal may be determined as the cyclic shift of the second cell identity value of the corresponding CD-synchronization signal according to:

N_{ID}^{Cell non-CD-SS}={N_{ID}^{Cell CD-SS}+Δ}₀^{N}.

Action 603. The UE 10 determines whether the non-CD-synchronization signal is associated with at least one CD-synchronization signal, and thereby transmitted from a same radio network node, based on the first cell identity value and the one or more second cell identity values. Upon the first cell identity value N_{ID}^{Cell non-CD-SS} of the non-CD synchronization signal being different from the second cell identity value N_{ID}^{Cell CD-SS} of the CD synchronization signal, the UE 10 may determine the CD synchronization signal associated with the non-CD synchronization signal by determining parameter N_{ID}^{Cell CD-SS} of the CD-synchronization signal as a reversed function of the first cell identity value N_{ID}^{Cell non-CD-SS} of the non-CD-synchronization signal, i.e. N_{ID}^{Cell CD-SS}=ƒ⁻¹ of (N_{ID}^{Cell non-CD-SS}) where the function ƒ( ) is known at the UE 10. The UE 10 may, when determined that the non-CD-synchronization signal is transmitted by the same radio network node, associate relevant system information obtained from the CD-synchronization signal to the non-CD synchronization signal. The UE 10 may determine that the CD-synchronization signal is associated to the non-CD-synchronization signal by estimating a parameter N_{ID}^{(1) CD-SS} of the CD-synchronization signal based on a parameter N_{ID}^{(1) non-CD-SS} as N_{ID}^{(1) CD-SS}=ƒ⁻¹(N_{ID}^{(1) non-CD-SS}) where the function ƒ( ) is known at the UE (10). The function ƒ( ) may be defined as a cyclic shift of the sum between the parameter N_{ID}^{(1) CD-SS} and a shift value Δ⁽¹⁾, wherein ƒ( ) is defined as

N_{ID}^{(1)non-CD-SS}=ƒ(N_{ID}^{(1)CD-SS})={N_{ID}^{(1)CD-SS}+Δ⁽¹⁾}₀^{N}

wherein Δ⁽¹⁾ is a positive or negative offset value, the notation {x}₀^{N} a cyclic shift operation on an argument x which projects x in the interval of integers {0, . . . , N}, and the integer N is a maximum range of the parameter N_{ID}^{(1) CD-SS} used for the CD synchronization signal.

Alternatively, the function ƒ( ) may be defined as a cyclic shift of the sum between the parameter N_{ID}^{Cell CD-SS} and a shift value Δ, wherein ƒ( ) is defined as

N_{ID}^{Cell non-CD-SS}=ƒ(N_{ID}^{Cell CD-SS})={N_{ID}^{cell CD-SS}+Δ}₀^{N}

wherein Δ⁽¹⁾ is a positive or negative offset value, the notation {x}₀^{N} denotes a projection of x in the interval of integers {0, . . . , N}, and the integer N is a maximum range of the second identity value N_{ID}^{Cell CD-SS} used for the CD synchronization signal.

According to embodiments herein the UE 10 may determine that the CD-synchronization signal is associated to the non-CD-synchronization signal by
a. estimating a parameter N_{ID}^{Cell CD-SS est} for the one or more CD-synchronization signal based the first cell identity value N_{ID}^{Cell non-CD-SS} as N_{ID}^{Cell CD-SS est}=ƒ⁻¹(N_{ID}^{Cell non-CD-SS}) where the function ƒ( ) is known at the UE (10);
b. comparing the estimated parameter N_{ID}^{(Cell CD-SS est} to the one or more second cell identity value parameter N_{ID}^{Cell CD-SS} of the one or more CD synchronization signals; and
c. associating the non-CD synchronization signal to the CD synchronization signal satisfying N_{ID}^{Cell CD-SS}=N_{ID}^{Cell CD-SS est}.

Upon the first cell identity value N_{ID}^{Cell non-CD-SS} of the non-CD synchronization signal being different from the second cell identity value N_{ID}^{Cell CD-SS} of the CD synchronization signal, the UE may determine the CD synchronization signal associated with the non-CD synchronization signal by determining the parameter N_{ID}^{(1) CD-SS} or N_{ID}^{(2) CD-SS} of the CD synchronization signal the same as the parameter N_{ID}^{(1) non-CD-SS} or N_{ID}^{(2) non-CD-SS} of the non-CD synchronization signal.

The UE may determine that the CD-synchronization signal is associated with the non-CD-synchronization signal based on the first cell identity value and the second cell identity value. The UE 10 may, upon the first cell identity value N_{ID}^{Cell non-CD-SS} of the non-CD synchronization signal being different from the second cell identity value N_{ID}^{Cell CD-SS} of the CD synchronization signal, determine the CD synchronization signal associated with the non-CD synchronization signal by determining the CD synchronization signal whose parameter N_{ID}^{(1) CD-SS} or N_{ID}^{(2) CD-SS} is the same as the parameter N_{ID}^{(1) non-CD-SS} or N_{ID}^{(2) non-CD-SS} of the non-CD synchronization signal. The N_{ID}^{(1) non-CD-SS} may be an integer encoded in a secondary synchronization signal transmission for the non-CD synchronization signal and N_{ID}^{(2) non-CD-SS} may be an integer encoded in the primary synchronization signal transmission for the non-CD synchronization signal; and wherein N_{ID}^{(1) CD-SS} is an integer encoded in a secondary synchronization signal transmission for the CD synchronization signal and N_{ID}^{(2) CD-SS} is an integer encoded in the primary synchronization signal transmission for the CD synchronization signal. N_{ID}^{(1) non-CD-SS} may be computed based on a cyclic shift of sum between a value N_{ID}^{(1) CD-SS} of the CD synchronization signal and an offset value Δ⁽¹⁾; wherein N_{ID}^{(1) CD-SS} is an integer encoded in a secondary synchronization signal transmission for the CD synchronization signal. The offset value Δ⁽¹⁾ may be a positive or negative integer. The first cell identity value, N_{ID}^{Cell non-CD-SS}, for the non-CD synchronization signal may comprise N_{ID}^{Cell non-CD-SS} as

$${N}_{ID}^{( 1 ) non \text{-} CD \text{-} SS} = {\{ {N}_{ID}^{( 1 ) CD \text{-} SS} + {Δ}^{( 1 )} \}}_{0}^{N} = \{ \begin{matrix}{N}_{ID}^{( 1 ) CD \text{-} SS} + {Δ}^{( 1 )} & if {N}_{ID}^{( 1 ) CD \text{-} SS} + {Δ}^{( 1 )} \leq N \\ {N}_{ID}^{( 1 ) CD \text{-} SS} + {Δ}^{( 1 )} - N - 1 & if {N}_{ID}^{( 1 ) CD \text{-} SS} + {Δ}^{( 1 )} > N\end{matrix}$$

where the notation {x}₀^{N} a cyclic shift operation on an argument x which projects x in the interval of integers {0, . . . , N}.

The integer value N may be used in the cyclic shift operation N_{ID}^{(1) non-CD-SS}={N_{ID}^{(1) CD-SS}+Δ⁽¹⁾}₀^{N} that is a maximum range of the parameter N_{ID}^{(1) CD-SS} used for the CD-signal. When the offset value Δ⁽¹⁾ is strictly greater than zero or strictly less than zero, and the integer N_{ID}^{(2) non-CD-SS} used to determine the first cell identity value N_{ID}^{Cell non-CD-SS} is chosen as either

N_{ID}^{(2)non-CD-SS}=N_{ID}^{(2)CD-SS} or
N_{ID}^{(2) non-CD-SS}≠N_{ID}^{(2) CD-SS}. w When the offset value Δ⁽¹⁾ is equal to zero, the N_{ID}^{(2) non-CD-SS} may be chosen as:

N_{ID}^{(2)non-CD-SS}≠N_{ID}^{(2)CD-SS}.

K non-CD synchronization signals associated with a single CD-synchronization signal may be configured by configuring the first cell identity value for each non-CD synchronization signal, N_{ID}^{(1) non-CD-SS}, with different shift values Δₖ⁽¹⁾ associated to the CD-synchronization signal as:

N_{ID}^{(1)non-CD-SS}={N_{ID}^{(1)CD-SS}+Δₖ⁽¹⁾}₀^{N},k=1, . . . ,K

Action 604. The UE 10 may further transmit a measurement report for the non-CD synchronization signal to the radio network node 12 associated to the CD synchronization signal, e.g. when determined that they are transmitted from same radio network node.

The method actions performed by the UE 10 for handling communication, such as managing or enabling detection of SI from the radio network node 12, in the wireless communication network 1 according to embodiments herein will now be described with reference to a flowchart depicted in FIG. 6B. The wireless communications network 1 comprises the UE 10 and the radio network node 12.

Action 611. The UE 10 receives the non-CD-SSB associated to the first cell identity value, wherein the first cell identity value is a function of the second cell identity value of the CD-SSB transmitted by the radio network node 12. E.g. the UE 10 may receive one or more CD-SSB and the non-CD-SSB signals at different frequency locations. This is an example of action 601 in FIG. 6A.

Action 612. The UE 10 may decode synchronization signal or signals of the CD-SSB and non-CD-SSB. This is an example of action 602 in FIG. 6A.

Action 613. The UE 10 then determines CD-SSB associated with the non-CD-SSB based on the first cell identity value. E.g. if the first PCI value N_{ID}^{Cell non-CD-SSB} of the non-CD-SSB is different from the second PCI value N_{ID}^{Cell CD-SSB} of the CD-SSBs, the UE 10 may determine the CD-SSB associated to the non-CD-SSB by determining the CD-SSB whose parameter N_{ID}^{(1) CD-SSB} (or N_{ID}^{(2) CD-SSB}) is the same as the parameter N_{ID}^{(1) non-CD-SSB} (or N_{ID}^{(2) non-CD-SSB}) of the non-CD-SSB. So that upon receiving and e.g. decoding the non-CD-SSB characterized by the first PCI value different from the second PCI value of CD-SSB, the UE 10 may still correctly associate the non-CD-SSB to the CD-SSB. This further allows the UE 10 to associate to the non-CD-SSB signal relevant system information obtained from the CD-SSB signal, such as SIB and MIB in the 3GPP LTE and 5G NR systems. This is an example of action 603 in FIG. 6A.

Action 614. The UE 10 may further transmit a measurement report for the non-CD-SSB to the radio network node 12 associated to the CD-SSB. This is an example of action 604 in FIG. 6A.

Embodiments herein disclose a method executed by the UE 10 to determine an association between a received non-CD-SSB signal and one or more received CD-SSB signals. In particular the method may comprise the actions of
Receiving one or more CD-SSB and a non-CD-SSB signals at different frequency locations;
Decoding PSS/SSS of the CD-SSB and non-CD-SSB and determine the corresponding PCI values;
If the first PCI value N_{ID}^{Cell non-CD-SSB} of the non-CD-SSB signal is different from the second PCI value N_{ID}^{Cell CD-SSB} of the CD-SSB signals, determine the CD-SSB signal associated to the non-CD-SSB by determining the CD-SSB whose parameter N_{ID}^{Cell CD-SSB} as a reversed function of the parameter N_{ID}^{Cell non-CD-SSB} of the non-CD-SSB, i.e. N_{ID}^{Cell CD-SSB}=ƒ⁻¹ (N_{ID}^{Cell non-CD-SSB}) where the function ƒ( ) is known at the UE 10.

Upon determining an association between a non-CD-SSB signal and a CD-SSB signal received by the UE 10, the UE 10 considers the non-CD-SSB signal to be transmitted by the same radio network node 12, the UE 10 is able to associate relevant system information obtained from the CD-SSB signal, such as the system information blocks (SIBs) and the master information block (MIB) to the non-CD-SSB.

In one embodiment, the UE 10 may determine the first PCI of the CD-SSB signal that is associated to the second PCI of a non-CD-SSB signal by estimating the parameter N_{ID}^{(1) CD-SSB} of the CD-SSB signal based on the parameter N_{ID}^{(1) non-CD-SSB} as N_{ID}^{(1) CD-SSB}=ƒ⁻¹(N_{ID}^{(1) non-CD-SSB}) where the function ƒ( ) is known at the UE 10. In one implementation of the method, the function ƒ( ) is defined as a cyclic shift of the sum between the parameter N_{ID}^{(1) CD-SSB} and a shift value Δ⁽¹⁾, i.e., ƒ( ) is defined as

N_{ID}^{(1)non-CD-SSB}=ƒ(N_{ID}^{(1)CD-SSB})={N_{ID}^{(1)CD-SSB}−Δ⁽¹⁾}₀^{N}.

Additional embodiments can be derived to map the various embodiments of the radio network node 12 above.

In one embodiment of the method, if the first PCI value N_{ID}^{Cell non-CD-SSB} of the non-CD-SSB signal is different from the second PCI value N_{ID}^{Cell CD-SSB} of the CD-SSB signals, determine the CD-SSB signal associated to the non-CD-SSB by determining the CD-SSB whose parameter N_{ID}^{(1) CD-SSB} (or N_{ID}^{(2) CD-SSB}) is the same as the parameter N_{ID}^{(1) non-CD-SSB} (or N_{ID}^{(2) non-CD-SSB}, respectively) of the non-CD-SSB.

Thanks to the embodiments herein, the first PCI value of non-CD-SSB, hence the non-CD-SSB, can be univocally associated to associated to a CD-SSB. Choosing to determine the PCI value of a non-CD-SSB using the same N_{ID}⁽¹⁾ value of a CD-SSB can considerably reduce the probability of misinterpreting the association between non-CD-SSB and CD-SSB (i.e., it is unlikely that a neighboring cell uses the same N_{ID}⁽¹⁾ value.

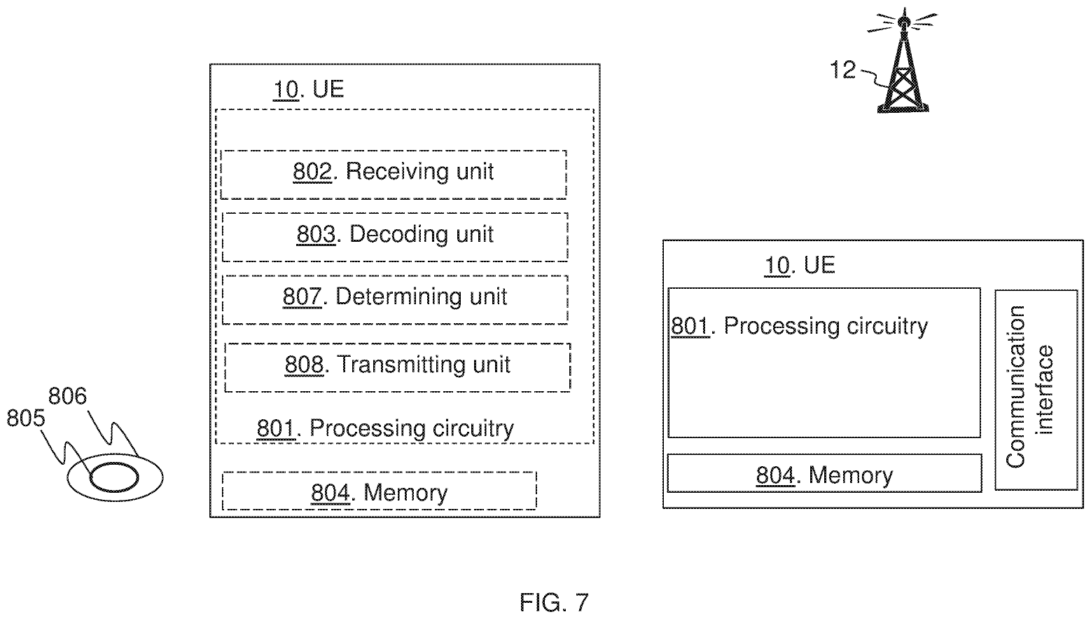

FIG. 7 is a block diagram depicting the UE 10, for handling communication, e.g. handling synchronization signals, in the wireless communications network 1 according to embodiments herein.

The UE 10 may comprise processing circuitry 801, e.g. one or more processors, configured to perform the methods herein.

The UE 10 may comprise a receiving unit 802, e.g. a receiver or transceiver or module. The UE 10, the processing circuitry 801, and/or the receiving unit 802 is configured to receive the non-CD synchronization signal, and the one or more CD synchronization signals. E.g. receive the non-CD-SSB associated to the first cell identity value, wherein the first cell identity value is a function of the second cell identity value of the CD-SSB transmitted by the radio network node 12. The UE 10, the processing circuitry 801, and/or the receiving unit 802 may be configured to receive the one or more CD-synchronization signals and the non-CD-synchronization signal at different frequency locations.

The UE 10 may comprise a decoding unit 803. The UE 10, the processing circuitry 801, and/or the decoding unit 803 is configured to decode the non-CD synchronization signal to determine the first cell identity value associated to the non-CD synchronization signal, and to decode the one or more CD synchronization signals to determine the one or more second cell identity values associated to the one or more CD synchronization. E.g. decode signals synchronization signal or signals of the CD-SSB and non-CD-SSB.

The UE 10 may comprise a determining unit 807. The UE 10, the processing circuitry 801, and/or the determining unit 807 is configured to determine whether the non-CD-synchronization signal is associated with at least one CD-synchronization signal, and thereby transmitted from a same radio network node, based on the first cell identity value and the one or more second cell identity values. E.g. determine that the CD-SSB is associated with the non-CD-SSB based on the first cell identity value or based on that the first PCI value is associated with the second PCI value, e.g. the same.

The UE 10 may comprise a transmitting unit 808, e.g. a transmitter or transceiver or module. The UE 10, the processing circuitry 801, and/or the transmitting unit 808 may be configured to transmit the measurement report for the non-CD synchronization signal to the radio network node 12 associated to the CD synchronization signal. E.g. transmit a measurement report for the non-CD-SSB to the radio network node 12 associated to the CD-SSB.

The non-CD synchronization signal may comprise a non-CD-SSB, and the CD synchronization signal may comprise a CD-SSB.

The first cell identity value may comprise a first PCI value and the second cell identity value may comprise a second PCI value.

When the first cell identity value N_{ID}^{Cell non-CD-SS} of the non-CD synchronization signal is different from the second cell identity value N_{ID}^{Cell CD-SS} of the CD synchronization signal, the UE 10, the processing circuitry 801, and/or the determining unit 807 may be configured to determine that the CD synchronization signal is associated with the non-CD synchronization signal by determining parameter N_{ID}^{Cell CD-SS} of the CD-synchronization signal as a reversed function of the first cell identity value N_{ID}^{Cell non-CD-SS} of the non-CD-synchronization signal.

When the UE 10, the processing circuitry 801, and/or the determining unit 807 determines that the non-CD-synchronization signal is transmitted by the same radio network node, the UE 10, the processing circuitry 801, and/or the determining unit 807 may be configured to associate relevant system information obtained from the CD-synchronization signal to the non-CD-synchronization signal. The UE 10, the processing circuitry 801, and/or the determining unit 807 may be configured to determine that the CD-synchronization signal is associated to the non-CD-synchronization signal by estimating a parameter N_{ID}^{(1) CD-SS} of the CD-synchronization signal based on a parameter N_{ID}^{(1) non-CD-SS} as N_{ID}^{(1) CD-SS}=ƒ⁻¹(N_{ID}^{(1) non-CD-SS}) where the function ƒ( ) is known at the UE (10). The function ƒ( ) may be defined as a cyclic shift of the sum between the parameter N_{ID}^{(1) CD-SS} and a shift value Δ⁽¹⁾, wherein ƒ( ) is defined as

N_{ID}^{(1)non-CD-SS}=ƒ(N_{ID}^{(1)CD-SS})={N_{ID}^{(1)CD-SS}+Δ⁽¹⁾}₀^{N}.

wherein Δ⁽¹⁾ is a positive or negative offset value, the notation {x}₀^{N} denotes a projection of x in the interval of integers {0, . . . , N}, and the integer N is a maximum range of the parameter N_{ID}^{(1) CD-SS} used for the CD synchronization signal.

The function ƒ( ) may be defined as a cyclic shift of the sum between the parameter N_{ID}^{Cell CD-SS} and a shift value Δ, wherein ƒ( ) is defined as

N_{ID}^{Cell non-CD-SS}=ƒ(N_{ID}^{Cell CD-SS})={N_{ID}^{Cell CD-SS}+Δ}₀^{N}

wherein Δ⁽¹⁾ is a positive or negative offset value, the notation {x}₀^{N} denotes a projection of x in the interval of integers {0, . . . , N}, and the integer N is a maximum range of the second identity value N_{ID}^{Cell CD-SS} used for the CD synchronization signal.

The UE 10, the processing circuitry 801, and/or the determining unit 807 may be configured to determine that the CD-synchronization signal is associated to the non-CD-synchronization signal by
a. estimating a parameter N_{ID}^{Cell CD-SS est} for the one or more CD-synchronization signal based the first cell identity value N_{ID}^{Cell non-CD-SS} as N_{ID}^{Cell CD-SS}=ƒ⁻¹(N_{ID}^{Cell non-CD-SS}) where the function ƒ( ) is known at the UE (10);
b. comparing the estimated parameter N_{ID}^{Cell CD-SS est} to the one or more second cell identity value parameter N_{ID}^{Cell CD-SS} of the one or more CD synchronization signals; and
c. associating the non-CD synchronization signal to the CD synchronization signal satisfying N_{ID}^{Cell CD-SS}=N_{ID}^{Cell CD-SS est}.

Upon the first cell identity value N_{ID}^{cell non-CD-SS} of the non-CD synchronization signal is different from the second cell identity value N_{ID}^{Cell CD-SS} of the CD synchronization signal, the UE 10, the processing circuitry 801, and/or the determining unit 807 may be configured to determine the CD synchronization signal associated with the non-CD synchronization signal by determining the CD synchronization signal whose parameter N_{ID}^{(1) CD-SS} or N_{ID}^{(2) CD-SS} is the same as the parameter N_{ID}^{(1) non-CD-SS} or N_{ID}^{(2) non-CD-SS} of the non-CD synchronization signal.

The UE 10 further comprises a memory 804. The memory 804 comprises one or more units to be used to store data on, such as SSBs, cell identities, measurements, SI and applications to perform the methods disclosed herein when being executed, and similar. Furthermore, the UE 10 may comprise a communication interface such as comprising a transmitter, a receiver and/or a transceiver and/or one or more antennas.

The methods according to the embodiments described herein for the UE 10 are respectively implemented by means of e.g. a computer program product 805 or a computer program, comprising instructions, i.e., software code portions, which, when executed on at least one processor, cause the at least one processor to carry out the actions described herein, as performed by the UE 10. The computer program product 805 may be stored on a computer-readable storage medium 806, e.g. a disc, a universal serial bus (USB) stick or similar. The computer-readable storage medium 806, having stored thereon the computer program product, may comprise the instructions which, when executed on at least one processor, cause the at least one processor to carry out the actions described herein, as performed by the UE 10. In some embodiments, the computer-readable storage medium may be a transitory or a non-transitory computer-readable storage medium. Thus, embodiments herein may disclose a UE for handling communication in a wireless communications network, wherein the UE comprises processing circuitry and a memory, said memory comprising instructions executable by said processing circuitry whereby said UE is operative to to perform any of the methods herein.

FIG. 8 is a block diagram depicting the radio network node 12 for handling communication, e.g. managing synchronization signals, in a wireless communications network 1 according to embodiments herein.

The radio network node 12 may comprise processing circuitry 901, e.g. one or more processors, configured to perform the methods herein.

The radio network node 12 may comprise a determining unit 902. The network node 12, the processing circuitry 901, and/or the determining unit 902 is configured to determine the first cell identity value for the non-CD synchronization signal, wherein the first cell identity value is determined as the function of the second cell identity value of the CD synchronization signal transmitted by the radio network node 12. The non-CD synchronization signal may comprise a non-CD-SSB, and the CD synchronization signal may comprise a CD-SSB. The radio network node 12, the processing circuitry 901, and/or the determining unit 902 may be configured to determine the first cell identity value such as PCI value for the non-CD-SSB as a function of the second cell identity value such as the second PCI value of the CD-SSB transmitted by the radio network node 12. The first cell identity value may be computed based on a cyclic shift associated to the CD-SSB.

The radio network node 12 may comprise a configuring unit 903. The network node 12, the processing circuitry 901, and/or the configuring unit 903 is configured to configure the non-CD synchronization signal based on said determined first cell identity value; e.g. to configure the non-CD-SSB signal based on said determined first cell identity value. The network node 12, the processing circuitry 901, and/or the configuring unit 903 may be configured to configure K non-CD synchronization signals associated with a single CD-synchronization signal by configuring the first cell identity value for each non-CD, synchronization signal, N_{ID}^{(1) non-CD-SS}, with different shift values Δₖ⁽¹⁾ associated to the CD-synchronization signal as:

N_{ID}^{(1)non-CD-SS}={N_{ID}^{(1)CD-SS}+Δₖ⁽¹⁾}₀^{N}k=1, . . . ,K.

The radio network node 12 may comprise a transmitting unit 907, e.g. a transmitter or transceiver or module. The network node 12, the processing circuitry 901, and/or the transmitting unit 907 is configured to transmit the non-CD synchronization signal as configured, e.g. to transmit the non-CD-SSB associated to the first cell identity value, wherein the first cell identity value is a function of the second cell identity value of the CD-SSB transmitted by the radio network node 12.

The first cell identity value may comprise the PCI value and the second cell identity value may comprise the second PCI value. The radio network node 12, the processing circuitry 901, and/or the determining unit 902 may be configured to determine the first cell identity value by computing the first cell identity value based on a cyclic shift associated to the CD-synchronization signal. The radio network node 12, the processing circuitry 901, and/or the determining unit 902 may be configured to determine the first cell identity value, N_{ID}^{Cell non-CD-SS}, for the non-CD synchronization signal by determining N_{ID}^{Cell non-CD-SS}=3N_{ID}^{(1) non-CD-SS}+N_{ID}^{(2) non-CD-SS}, wherein N_{ID}^{(1) non-CD-SS} is an integer for the non-CD synchronization signal and N_{ID}^{(2) non-CD-SS} is an integer for the non-CD synchronization signal; and wherein N_{ID}^{(1) non-CD-SS} is computed based on a cyclic shift of sum between a value N_{ID}^{(1) CD-SS} of the CDsynchronization signal and an offset value Δ⁽¹⁾; wherein N_{ID}^{(1) CD-SS} is an integer for the CD synchronization signal. The offset value Δ⁽¹⁾ may be a positive or negative integer. The radio network node 12, the processing circuitry 901, and/or the determining unit 902 may be configured to determine the first cell identity value, N_{ID}^{Cell non-CD-SS}, for the non-CD synchronization signal by determining N_{ID}^{(1) non-CD-SS} as

$${N}_{ID}^{( 1 ) non \text{-} CD \text{-} SS} = {\{ {N}_{ID}^{( 1 ) CD \text{-} SS} + {Δ}^{( 1 )} \}}_{0}^{N} = \{ \begin{matrix}{N}_{ID}^{( 1 ) CD \text{-} SS} + {Δ}^{( 1 )} & if {N}_{ID}^{( 1 ) CD \text{-} SS} + {Δ}^{( 1 )} \leq N \\ {N}_{ID}^{( 1 ) CD \text{-} SS} + {Δ}^{( 1 )} - N - 1 & if {N}_{ID}^{( 1 ) CD \text{-} SS} + {Δ}^{( 1 )} > N\end{matrix}$$

where the notation {x}₀^{N} denotes a projection of x in the interval of integers {0, . . . , N}.

The radio network node 12, the processing circuitry 901, and/or the determining unit 902 may be configured to determine the first cell identity value, N_{ID}^{Cell non-CD-SS}, for the non-CD synchronization signal by determining N_{ID}^{(1) non-CD-SS} as N_{ID}^{(1) non-CD-SS}={N_{ID}^{(1) CD-SS}−Δ⁽¹⁾}₀^{N}. The integer value N may be used in the cyclic shift operation N_{ID}^{(1) non-CD-SS}={N_{ID}^{(1) CD-SS}±Δ(1)}₀^{N} is a maximum range of the parameter N_{ID}^{(1) CD-SS} used for the CD synchronization signal. When the offset value Δ⁽¹⁾ is strictly greater than zero or strictly less than zero, and the integer N_{ID}^{(2) non-CD-SS} used to determine the first cell identity value N_{ID}^{Cell non-CD-SS} may be chosen as either

N_{ID}^{(2)non-CD-SS}=N_{ID}^{(2)CD-SS} or
N_{ID}^{(2) non-CD-SS}≠N_{ID}^{(2) CD-SS}, wherein N_{ID}^{(2) CD-SS} is a second integer for the CD-synchronization signal.

When the offset value Δ⁽¹⁾ is equal to zero, the N_{ID}^{(2) non-CD-SS} may be chosen as

N_{ID}^{(2)non-CD-SS}≠N_{ID}^{(2)CD-SS}.

The first cell identity value, N_{ID}^{Cell non-CD-SS}, for the non-CD-synchronization signal may be determined as a cyclic shift of the second cell identity value of the corresponding CD-synchronization signal according to:

N_{ID}^{Cell non-CD-SS}={N_{ID}^{Cell CD-SS}±Δ}₀^{N}.

The integer value N used in the cyclic shift operation N_{ID}^{Cell non-CD-SS}={N_{ID}^{Cell CD-SS}±Δ}₀^{N} may be a maximum range of the parameter N_{ID}^{Cell CD-SS} used for the CD synchronization signal.

The radio network node 12, the processing circuitry 901, and/or the determining unit 902 may be configured to determine the first cell identity value, N_{ID}^{Cell non-CD-SS} for the non-CD synchronization signal by determining the first cell identity value N_{ID}^{Cell non-CD-SS}=3N_{ID}^{(1) non-CD-SS}+N_{ID}^{(2) non-CD-SS} wherein N_{ID}^{(1) non-CD-SS} is constrained to be equal to the value N_{ID}^{(1) CD-SS} of the corresponding CD-synchronization signal and N_{ID}^{(2) non-CD-SS} is different from N_{ID}^{(2) CD-SS}.

The radio network node 12, the processing circuitry 901, and/or the determining unit 902 may be configured to determine the first cell identity value, N_{ID}^{Cell non-CD-SS}, for the non-CD synchronization signal by determining the first cell identity value as N_{ID}^{Cell}=3N_{ID}^{(1) non-CD-SS}+N_{ID}^{(2) non-CD-SS}, wherein N_{ID}^{(2) non-CD-SS} is constrained to be the same as the N_{ID}^{(2) CD-SS} value of the corresponding CD-synchronization signal and N_{ID}^{(1) non-CD-SS} is different.

The non-CD synchronization signal and the CD synchronization signal may be transmitted at different frequency locations.

The radio network node 12 further comprises a memory 904. The memory 904 comprises one or more units to be used to store data on, such as SSBs, cell identities, measurements, SI and applications to perform the methods disclosed herein when being executed, and similar. Furthermore, the radio network node 12 may comprise a communication interface such as comprising a transmitter, a receiver and/or a transceiver and/or one or more antennas.

The methods according to the embodiments described herein for the radio network node 12 are respectively implemented by means of e.g. a computer program product 905 or a computer program, comprising instructions, i.e., software code portions, which, when executed on at least one processor, cause the at least one processor to carry out the actions described herein, as performed by the radio network node 12. The computer program product 905 may be stored on a computer-readable storage medium 906, e.g. a disc, a universal serial bus (USB) stick or similar. The computer-readable storage medium 906, having stored thereon the computer program product, may comprise the instructions which, when executed on at least one processor, cause the at least one processor to carry out the actions described herein, as performed by the radio network node 12. In some embodiments, the computer-readable storage medium may be a transitory or a non-transitory computer-readable storage medium. Thus, embodiments herein may disclose a radio network node for handling communication in a wireless communications network, wherein the radio network node comprises processing circuitry and a memory, said memory comprising instructions executable by said processing circuitry whereby said radio network node is operative to to perform any of the methods herein.

In some embodiments a more general term “radio network node” is used and it can correspond to any type of radio-network node or any network node, which communicates with a wireless device and/or with another network node. Examples of network nodes are NodeB, MeNB, SeNB, a network node belonging to Master cell group (MCG) or Secondary cell group (SCG), base station (BS), multi-standard radio (MSR) radio node such as MSR BS, eNodeB, network controller, radio-network controller (RNC), base station controller (BSC), relay, donor node controlling relay, base transceiver station (BTS), access point (AP), transmission points, transmission nodes, Remote radio Unit (RRU), Remote Radio Head (RRH), nodes in distributed antenna system (DAS), etc.

In some embodiments the non-limiting term wireless device or user equipment (UE) is used and it refers to any type of wireless device communicating with a network node and/or with another wireless device in a cellular or mobile communication system. Examples of UE are target device, device to device (D2D) UE, proximity capable UE (aka ProSe UE), machine type UE or UE capable of machine to machine (M2M) communication, Tablet, mobile terminals, smart phone, laptop embedded equipped (LEE), laptop mounted equipment (LME), USB dongles etc.

Embodiments are applicable to any RAT or multi-RAT systems, where the wireless device receives and/or transmit signals (e.g. data) e.g. New Radio (NR), Wi-Fi, Long Term Evolution (LTE), LTE-Advanced, Wideband Code Division Multiple Access (WCDMA), Global System for Mobile communications/enhanced Data rate for GSM Evolution (GSM/EDGE), Worldwide Interoperability for Microwave Access (WiMax), or Ultra Mobile Broadband (UMB), just to mention a few possible implementations.

As will be readily understood by those familiar with communications design, that functions means or circuits may be implemented using digital logic and/or one or more microcontrollers, microprocessors, or other digital hardware. In some embodiments, several or all of the various functions may be implemented together, such as in a single application-specific integrated circuit (ASIC), or in two or more separate devices with appropriate hardware and/or software interfaces between them. Several of the functions may be implemented on a processor shared with other functional components of a wireless device or network node, for example.

Alternatively, several of the functional elements of the processing means discussed may be provided through the use of dedicated hardware, while others are provided with hardware for executing software, in association with the appropriate software or firmware. Thus, the term “processor” or “controller” as used herein does not exclusively refer to hardware capable of executing software and may implicitly include, without limitation, digital signal processor (DSP) hardware and/or program or application data. Other hardware, conventional and/or custom, may also be included. Designers of communications devices will appreciate the cost, performance, and maintenance trade-offs inherent in these design choices.

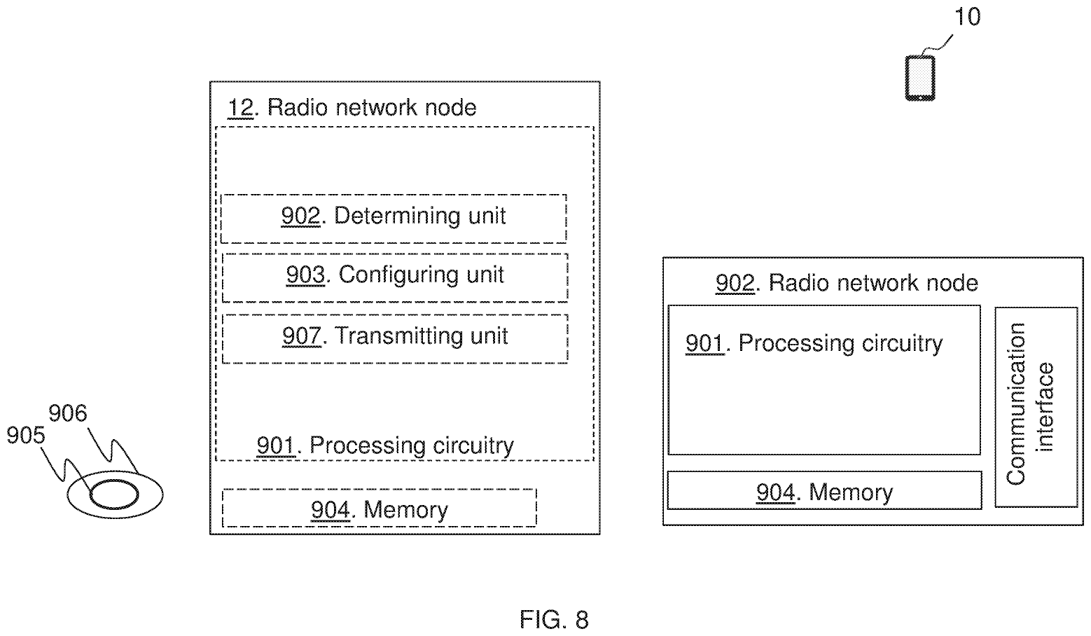

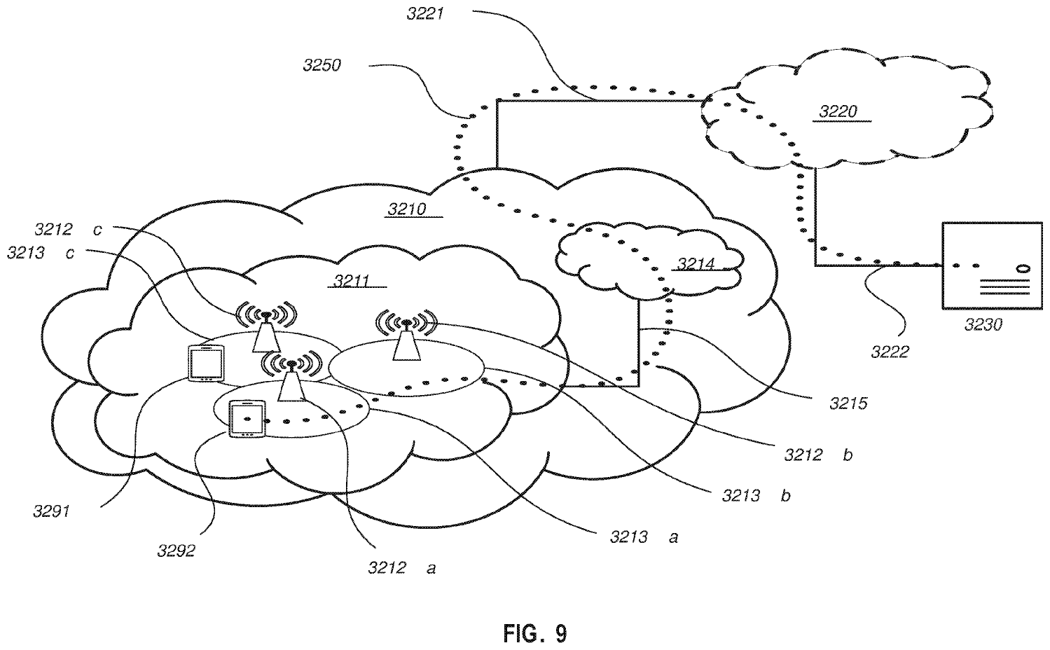

FIG. 9 shows a Telecommunication network connected via an intermediate network to a host computer in accordance with some embodiments. With reference to FIG. 15, in accordance with an embodiment, a communication system includes telecommunication network 3210, such as a 3GPP-type cellular network, which comprises access network 3211, such as a radio access network, and core network 3214. Access network 3211 comprises a plurality of base stations 3212a, 3212b, 3212c, such as NBs, eNBs, gNBs or other types of wireless access points being examples of the radio network node 12 above, each defining a corresponding coverage area 3213a, 3213b, 3213c. Each base station 3212a, 3212b, 3212c is connectable to core network 3214 over a wired or wireless connection 3215. A first UE 3291 located in coverage area 3213c is configured to wirelessly connect to, or be paged by, the corresponding base station 3212c. A second UE 3292 in coverage area 3213a is wirelessly connectable to the corresponding base station 3212a. While a plurality of UEs 3291, 3292 are illustrated in this example being examples of the UE 10 above, the disclosed embodiments are equally applicable to a situation where a sole UE is in the coverage area or where a sole UE is connecting to the corresponding base station 3212.

Telecommunication network 3210 is itself connected to host computer 3230, which may be embodied in the hardware and/or software of a standalone server, a cloud-implemented server, a distributed server or as processing resources in a server farm. Host computer 3230 may be under the ownership or control of a service provider, or may be operated by the service provider or on behalf of the service provider. Connections 3221 and 3222 between telecommunication network 3210 and host computer 3230 may extend directly from core network 3214 to host computer 3230 or may go via an optional intermediate network 3220. Intermediate network 3220 may be one of, or a combination of more than one of, a public, private or hosted network; intermediate network 3220, if any, may be a backbone network or the Internet; in particular, intermediate network 3220 may comprise two or more sub-networks (not shown).

The communication system of FIG. 9 as a whole enables connectivity between the connected UEs 3291, 3292 and host computer 3230. The connectivity may be described as an over-the-top (OTT) connection 3250. Host computer 3230 and the connected UEs 3291, 3292 are configured to communicate data and/or signaling via OTT connection 3250, using access network 3211, core network 3214, any intermediate network 3220 and possible further infrastructure (not shown) as intermediaries. OTT connection 3250 may be transparent in the sense that the participating communication devices through which OTT connection 3250 passes are unaware of routing of uplink and downlink communications. For example, base station 3212 may not or need not be informed about the past routing of an incoming downlink communication with data originating from host computer 3230 to be forwarded (e.g., handed over) to a connected UE 3291. Similarly, base station 3212 need not be aware of the future routing of an outgoing uplink communication originating from the UE 3291 towards the host computer 3230.

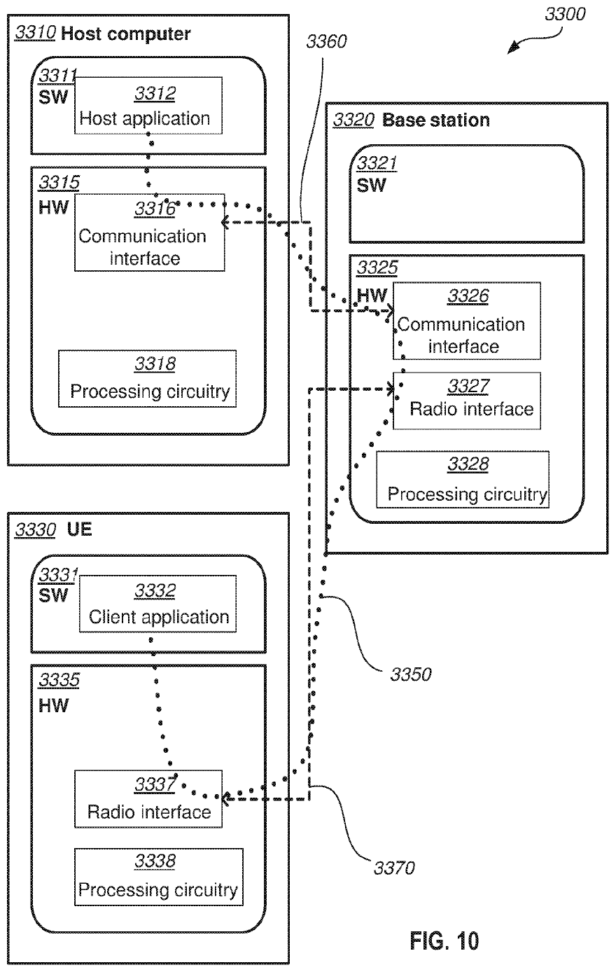

FIG. 10 shows a host computer communicating via a base station and with a user equipment over a partially wireless connection in accordance with some embodiments

Example implementations, in accordance with an embodiment, of the UE, base station and host computer discussed in the preceding paragraphs will now be described with reference to FIG. 10. In communication system 3300, host computer 3310 comprises hardware 3315 including communication interface 3316 configured to set up and maintain a wired or wireless connection with an interface of a different communication device of communication system 3300. Host computer 3310 further comprises processing circuitry 3318, which may have storage and/or processing capabilities. In particular, processing circuitry 3318 may comprise one or more programmable processors, application-specific integrated circuits, field programmable gate arrays or combinations of these (not shown) adapted to execute instructions. Host computer 3310 further comprises software 3311, which is stored in or accessible by host computer 3310 and executable by processing circuitry 3318. Software 3311 includes host application 3312. Host application 3312 may be operable to provide a service to a remote user, such as UE 3330 connecting via OTT connection 3350 terminating at UE 3330 and host computer 3310. In providing the service to the remote user, host application 3312 may provide user data which is transmitted using OTT connection 3350.

Communication system 3300 further includes base station 3320 provided in a telecommunication system and comprising hardware 3325 enabling it to communicate with host computer 3310 and with UE 3330. Hardware 3325 may include communication interface 3326 for setting up and maintaining a wired or wireless connection with an interface of a different communication device of communication system 3300, as well as radio interface 3327 for setting up and maintaining at least wireless connection 3370 with UE 3330 located in a coverage area (not shown in FIG. 10) served by base station 3320. Communication interface 3326 may be configured to facilitate connection 3360 to host computer 3310. Connection 3360 may be direct or it may pass through a core network (not shown in FIG. 10) of the telecommunication system and/or through one or more intermediate networks outside the telecommunication system. In the embodiment shown, hardware 3325 of base station 3320 further includes processing circuitry 3328, which may comprise one or more programmable processors, application-specific integrated circuits, field programmable gate arrays or combinations of these (not shown) adapted to execute instructions. Base station 3320 further has software 3321 stored internally or accessible via an external connection.

Communication system 3300 further includes UE 3330 already referred to. It's hardware 3333 may include radio interface 3337 configured to set up and maintain wireless connection 3370 with a base station serving a coverage area in which UE 3330 is currently located. Hardware 3333 of UE 3330 further includes processing circuitry 3338, which may comprise one or more programmable processors, application-specific integrated circuits, field programmable gate arrays or combinations of these (not shown) adapted to execute instructions. UE 3330 further comprises software 3331, which is stored in or accessible by UE 3330 and executable by processing circuitry 3338. Software 3331 includes client application 3332. Client application 3332 may be operable to provide a service to a human or non-human user via UE 3330, with the support of host computer 3310. In host computer 3310, an executing host application 3312 may communicate with the executing client application 3332 via OTT connection 3350 terminating at UE 3330 and host computer 3310. In providing the service to the user, client application 3332 may receive request data from host application 3312 and provide user data in response to the request data. OTT connection 3350 may transfer both the request data and the user data. Client application 3332 may interact with the user to generate the user data that it provides.

It is noted that host computer 3310, base station 3320 and UE 3330 illustrated in FIG. 10 may be similar or identical to host computer 3230, one of base stations 3212a, 3212b, 3212c and one of UEs 3291, 3292 of FIG. 9, respectively. This is to say, the inner workings of these entities may be as shown in FIG. 10 and independently, the surrounding network topology may be that of FIG. 9.

In FIG. 10, OTT connection 3350 has been drawn abstractly to illustrate the communication between host computer 3310 and UE 3330 via base station 3320, without explicit reference to any intermediary devices and the precise routing of messages via these devices. Network infrastructure may determine the routing, which it may be configured to hide from UE 3330 or from the service provider operating host computer 3310, or both. While OTT connection 3350 is active, the network infrastructure may further take decisions by which it dynamically changes the routing (e.g., on the basis of load balancing consideration or reconfiguration of the network).

Wireless connection 3370 between UE 3330 and base station 3320 is in accordance with the teachings of the embodiments described throughout this disclosure. One or more of the various embodiments improve the performance of OTT services provided to UE 3330 using OTT connection 3350, in which wireless connection 3370 forms the last segment. More precisely, the teachings of these embodiments make it possible to enable the UE to find SI related to non-CD-SSB reducing latency and improved responsiveness.

Thereby the data communication, such as handle or manage synchronization or system information, may be performed in an efficient manner.

A measurement procedure may be provided for the purpose of monitoring data rate, latency and other factors on which the one or more embodiments improve. There may further be an optional network functionality for reconfiguring OTT connection 3350 between host computer 3310 and UE 3330, in response to variations in the measurement results. The measurement procedure and/or the network functionality for reconfiguring OTT connection 3350 may be implemented in software 3311 and hardware 3315 of host computer 3310 or in software 3331 and hardware 3333 of UE 3330, or both. In embodiments, sensors (not shown) may be deployed in or in association with communication devices through which OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of OTT connection 3350 may include message format, retransmission settings, preferred routing etc.; the reconfiguring need not affect base station 3320, and itmay be unknown or imperceptible to base station 3320. Such procedures and functionalities may be known and practiced in the art. In certain embodiments, measurements may involve proprietary UE signaling facilitating host computer 3310's measurements of throughput, propagation times, latency and the like. The measurements may be implemented in that software 3311 and 3331 causes messages to be transmitted, in particular empty or ‘dummy’ messages, using OTT connection 3350 while it monitors propagation times, errors etc.

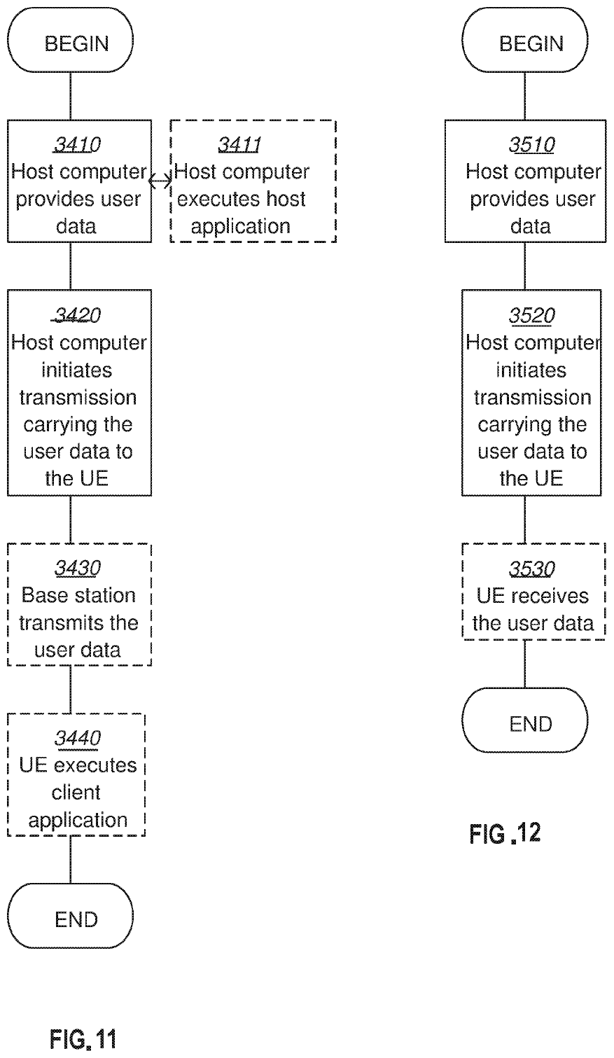

FIG. 11 shows methods implemented in a communication system including a host computer, a base station and a user equipment in accordance with some embodiments.

FIG. 11 is a flowchart illustrating a method implemented in a communication system, in accordance with one embodiment. The communication system includes a host computer, a base station and a UE which may be those described with reference to FIG. 9 and FIG. 10. For simplicity of the present disclosure, only drawing references to FIG. 11 will be included in this section. In step 3410, the host computer provides user data. In substep 3411 (which may be optional) of step 3410, the host computer provides the user data by executing a host application. In step 3420, the host computer initiates a transmission carrying the user data to the UE. In step 3430 (which may be optional), the base station transmits to the UE the user data which was carried in the transmission that the host computer initiated, in accordance with the teachings of the embodiments described throughout this disclosure. In step 3440 (which may also be optional), the UE executes a client application associated with the host application executed by the host computer.

FIG. 12 shows methods implemented in a communication system including a host computer, a base station and a user equipment in accordance with some embodiments.

FIG. 12 is a flowchart illustrating a method implemented in a communication system, in accordance with one embodiment. The communication system includes a host computer, a base station and a UE which may be those described with reference to FIG. 9 and FIG. 10. For simplicity of the present disclosure, only drawing references to FIG. 12 will be included in this section. In step 3510 of the method, the host computer provides user data. In an optional substep (not shown) the host computer provides the user data by executing a host application. In step 3520, the host computer initiates a transmission carrying the user data to the UE. The transmission may pass via the base station, in accordance with the teachings of the embodiments described throughout this disclosure. In step 3530 (which may be optional), the UE receives the user data carried in the transmission.

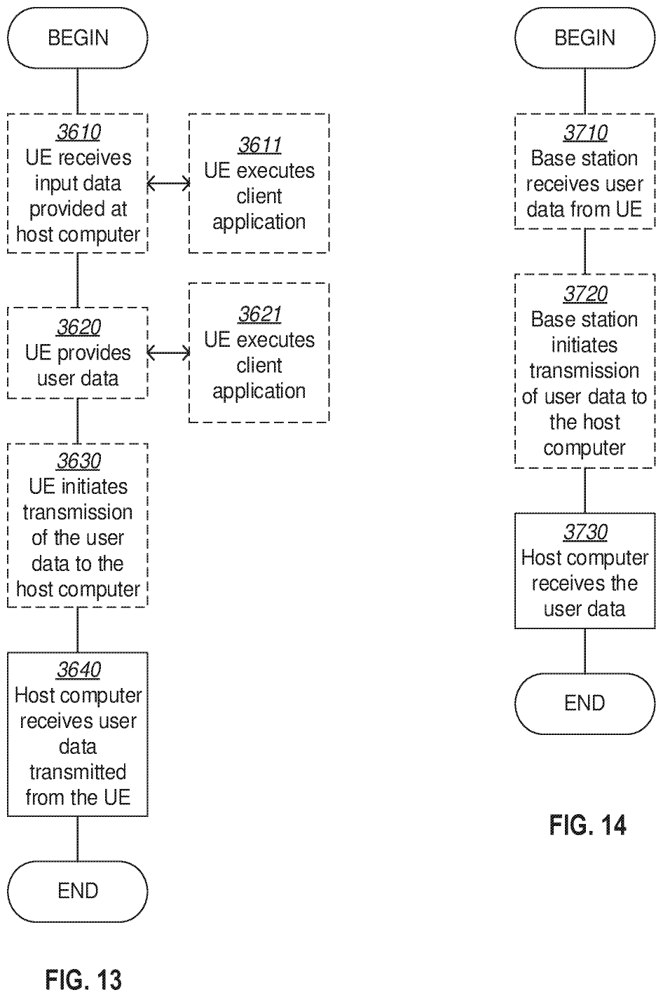

FIG. 13 shows methods implemented in a communication system including a host computer, a base station and a user equipment in accordance with some embodiments.

FIG. 13 is a flowchart illustrating a method implemented in a communication system, in accordance with one embodiment. The communication system includes a host computer, a base station and a UE which may be those described with reference to FIG. 9 and FIG. 10. For simplicity of the present disclosure, only drawing references to FIG. 13 will be included in this section. In step 3610 (which may be optional), the UE receives input data provided by the host computer. Additionally or alternatively, in step 3620, the UE provides user data. In substep 3621 (which may be optional) of step 3620, the UE provides the user data by executing a client application. In substep 3611 (which may be optional) of step 3610, the UE executes a client application which provides the user data in reaction to the received input data provided by the host computer. In providing the user data, the executed client application may further consider user input received from the user. Regardless of the specific manner in which the user data was provided, the UE initiates, in substep 3630 (which may be optional), transmission of the user data to the host computer. In step 3640 of the method, the host computer receives the user data transmitted from the UE, in accordance with the teachings of the embodiments described throughout this disclosure.

FIG. 14 show methods implemented in a communication system including a host computer, a base station and a user equipment in accordance with some embodiments.

FIG. 14 is a flowchart illustrating a method implemented in a communication system, in accordance with one embodiment. The communication system includes a host computer, a base station and a UE which may be those described with reference to FIG. 9 and FIG. 10. For simplicity of the present disclosure, only drawing references to FIG. 14 will be included in this section. In step 3710 (which may be optional), in accordance with the teachings of the embodiments described throughout this disclosure, the base station receives user data from the UE. In step 3720 (which may be optional), the base station initiates transmission of the received user data to the host computer. In step 3730 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

It will be appreciated that the foregoing description and the accompanying drawings represent non-limiting examples of the methods and apparatus taught herein. As such, the apparatus and techniques taught herein are not limited by the foregoing description and accompanying drawings. Instead, the embodiments herein are limited only by the following claims and their legal equivalents.

### ABBREVIATION EXPLANATION

ACK (positive) Acknowledgment
AUL Autonomous uplink
BLER Block error rate
BWP Bandwidth Part
CAPC Channel access priority class
CBG Code block group
CCA Clear channel assessment
CO Channel occupancy
COT Channel occupancy time
CWS Contention window size
DL Downlink
ED Energy detection
eNB 4G base station
gNB 5G base station
HARQ Hybrid automatic repeat request
IS In synch
LAA Licensed assisted access
LBT Listen before talk
MAC Medium access control
MOOT Maximum channel occupancy time
NACK Negative acknowledgment
NDI New data indicator
NR 3GPP defined 5G radio access technology
NR-U NR unlicensed
OOS out of synch
PCell Primary cell
PCI Physical cell identity
PDCCH Physical downlink control channel
PDU Protocol data unit
PHICH Physical channel Hybrid ARQ Indicator Channel
PLMN Public land mobile network
PSCell Primary SCG cell
PUCCH Physical Uplink Control Channel
PUSCH Physical Uplink Shared Channel
QCI QoS class identifier
QoS Quality of service
RAT Radio access technology
RLF Radio link failure
RLM Radio link monitoring
RLC Radio link control
RRC Radio resource control
RS Reference signal
SCG Secondary cell group
SDU Service data unit
SMTC SSBbased measurement timing configuration
SpCell Special cell (PCell or PSCell)
SPS Semi persistent scheduling
TTI Transmission time interval
UCI Uplink Control Information
UE User equipment
UL Uplink

1. A method performed by a radio network node for managing synchronization signals in a wireless communication network, the method comprising
determining a first cell identity value for a non-cell defining, non-CD, synchronization signal, wherein the first cell identity value is determined as a function of a second cell identity value of a cell defining, CD, synchronization signal transmitted by the radio network node;
configuring the non-CD synchronization signal based on said determined first cell identity value; and
transmitting the non-CD synchronization signal as configured.

2. The method according to claim 1, wherein the non-CD synchronization signal comprises a non-cell defining synchronization signal block, non-CD-SSB, and the CD synchronization signal comprises a cell defining synchronization signal block, CD-SSB.

3. The method according to claim 1, wherein the first cell identity value comprises a first physical cell identity value and the second cell identity value comprises a second physical cell identity value.

4. The method according to claim 1, wherein determining the first cell identity value comprises computing the first cell identity value based on a cyclic shift associated to the CD-synchronization signal.

5. The method according to claim 1, wherein determining the first cell identity value, N_{ID}^{Cell non-CD-SS}, for the non-CD synchronization signal comprises determining N_{ID}^{Cell non-CD-SS}=3N_{ID}^{(1) non-CD-SS}+N_{ID}^{(2) non-CD-SS} wherein N_{ID}^{(1) non-CD-SS} is an integer for the non-CD synchronization signal and N_{ID}^{(2) non-CD-SS} is an integer for the non-CD synchronization signal; and wherein N_{ID}^{(1) non-CD-SS} is computed based on a cyclic shift of sum between a value N_{ID}^{(1) non-CD-SS} of the CD synchronization signal and an offset value Δ⁽¹⁾; wherein N_{ID}^{(1) CD-SS} is an integer for the CD synchronization signal.

6. The method according to claim 5, wherein the offset value Δ⁽¹⁾ is a positive or negative integer.

7. The method according to claim 5, wherein determining the first cell identity value, N_{ID}^{Cell non-CD-SS}, for the non-CD synchronization signal comprises determining N_{ID}^{(1) non-CD-SS} as
$${N}_{ID}^{( 1 ) non \text{-} CD \text{-} SS} = {\{ {N}_{ID}^{( 1 ) CD \text{-} SS} + {Δ}^{( 1 )} \}}_{0}^{N} = \{ \begin{matrix}{N}_{ID}^{( 1 ) CD \text{-} SS} + {Δ}^{( 1 )} & if {N}_{ID}^{( 1 ) CD \text{-} SS} + {Δ}^{( 1 )} \leq N \\ {N}_{ID}^{( 1 ) CD \text{-} SS} + {Δ}^{( 1 )} - N - 1 & if {N}_{ID}^{( 1 ) CD \text{-} SS} + {Δ}^{( 1 )} > N\end{matrix}$$
where the notation {x}₀^{N} denotes a cyclic shift operation on an argument x which projects x in the interval of integers {0, . . . , N}.

8. The method according to claim 5, wherein determining the first cell identity value, N_{ID}^{Cell non-CD-SS}, for the non-CD synchronization signal comprises determining N_{ID}^{(1) non-CD-SS} as N_{ID}^{(1) non-CD-SS}={N_{ID}^{(1) CD-SS}±Δ⁽¹⁾}₀^{N}.

9. The method according to claim 5, wherein the integer value N used in the cyclic shift operation N_{ID}^{(1) non-CD-SS}={N_{ID}^{(1) CD-SS}±Δ⁽¹⁾}₀^{N} is a maximum range of the parameter N_{ID}^{(1) CD-SS} used for the CD synchronization signal.

10. The method according to claim 5, wherein the offset value Δ⁽¹⁾ is strictly greater than zero or strictly less than zero, and the integer N_{ID}^{(2) non-CD-SS} used to determine the first cell identity value N_{ID}^{Cell non-CD-SS} is chosen as either
N_{ID}^{(2)non-CD-SS}=N_{ID}^{(2)CD-SS} or
N_{ID}^{(2)non-CD-SS}≠N_{ID}^{(2)CD-SS}
wherein N_{ID}^{(2) CD-SS} is a second integer for the CD-synchronization signal.

11.-17. (canceled)

18. A method performed by a user equipment, UE, for handling synchronization signals, from a radio network node in a wireless communication network, the method comprising:
receiving a non-cell defining, non-CD, synchronization signal, and one or more cell defining, CD, synchronization signals;
decoding the non-CD synchronization signal to determine a first cell identity value associated to the non-CD synchronization signal;
decoding the one or more CD synchronization signals to determine one or more second cell identity values associated to the one or more CD synchronization signals; and
determining whether the non-CD-synchronization signal is associated with at least one CD-synchronization signal, and thereby transmitted from a same radio network node, based on the first cell identity value and the one or more second cell identity values.

19. The method according to claim 18, wherein the UE 044 receives the one or more CD-synchronization signals and the non-CD-synchronization signal at different frequency locations.

20. The method according to claim 18, wherein the non-CD synchronization signal comprises a non-cell defining synchronization signal block, non-CD-SSB, and the CD synchronization signal comprises a cell defining synchronization signal block, CD-SSB.

21. The method according to claim 18, wherein the first cell identity value comprises a first physical cell identity value and the second cell identity value comprises a second physical cell identity value.

22. The method according to claim 18, upon the first cell identity value N_{ID}^{Cell non-CD-SS} of the non-CD synchronization signal is different from the second cell identity value N_{ID}^{Cell non-CD-SS} of the CD synchronization signal, determining the CD synchronization signal associated with the non-CD synchronization signal by determining parameter N_{ID}^{Cell non-CD-SS} of the CD synchronization signal as a reversed function of the first cell identity value N_{ID}^{Cell non-CD-SS} of the non-CD-synchronization signal.

23.-29. (canceled)

30. A radio network node for managing synchronization signals in a wireless communication network, wherein the radio network node is configured to:
determine a first cell identity value for a non-cell defining, non-CD, synchronization signal, wherein the first cell identity value is determined as a function of a second cell identity value of a cell defining, CD, synchronization signal transmitted by the radio network node;
configure the non-CD synchronization signal based on said determined first cell identity value; and
transmit the non-CD synchronization signal as configured.

31.-46. (canceled)

47. A user equipment, UE, for handling synchronization signals, from a radio network node in a wireless communication network, wherein the UE is configured to:
receive a non-cell defining, non-CD, synchronization signal, and one or more cell defining, CD, synchronization signals;
decode the non-CD synchronization signal to determine a first cell identity value associated to the non-CD synchronization signal;
decode the one or more CD synchronization signals to determine one or more second cell identity values associated to the one or more CD synchronization signals; and
determine whether the non-CD-synchronization signal is associated with at least one CD-synchronization signal, and thereby transmitted from a same radio network node, based on the first cell identity value and the one or more second cell identity values.

48.-60. (canceled)
